(19) United States
(12) Patent Application Publication
(10) Pub. No.: US 2026/0093350 A1
(43) Pub. Date: Apr. 2, 2026

(54) POSITION DETECTION DEVICE AND DISPLAY DEVICE

(71) Applicant: Wacom Co., Ltd., Saitama (JP)

(72) Inventors: Joo Hoon LEE, Saitama (JP); Hiroshi MIZUHASHI, Saitama (JP); Fumitaka GOTO, Saitama (JP)

(73) Assignee: Wacom Co., Ltd., Saitama (JP)

(21) Appl. No.: 19/413,944

(22) Filed: Dec. 9, 2025

Related U.S. Application Data
(63) Continuation of application No. PCT/JP2024/023181, filed on Jun. 26, 2024.
(60) Provisional application No. 63/510,440, filed on Jun. 27, 2023.
(60) Provisional application No. 63/517,550, filed on Aug. 3, 2023.

(30) Foreign Application Priority Data
Nov. 17, 2023 (JP) 2023-196190

(51) Int. Cl. G06F 3/038; G06F 3/0354; G06F 3/044; G06F 3/046

(52) U.S. Cl. CPC G06F 3/0383; G06F 3/03545; G06F 3/0442; G06F 3/0445; G06F 3/046; G06F 2203/04112; G06F 2203/04114

(57) ABSTRACT

A position detecting device is provided for detecting a position of a pen by using electromagnetic induction action. The position detecting device includes a first electrode layer provided with a first electrode configured to generate an alternating magnetic field, a display layer configured to control display pixels and blinking of the display pixels, and a second electrode layer provided with a plurality of second electrodes configured to detect a pen alternating magnetic field generated by the pen that has stored energy through the alternating magnetic field. The second electrode layer is on an opposite side of the display layer from a side provided with the first electrode layer.

### BACKGROUND

### Technical Field

The present disclosure relates to a position detecting device and a display device.

### Description of the Related Art

Recently, a position input device based on an electromagnetic induction system has been used as, for example, an input device of a tablet PC (personal computer) or the like.

This position input device includes a position indicator in a pen shape (pen type position indicator), and a position detecting device that has an input surface for performing a pointing operation and input of a character, a figure, or the like by using the pen type position indicator.

The position indicator includes a resonance circuit constituted by a coil and a capacitor.

As illustrated in FIG. 9, in order to obtain the coordinate in an X-axis direction of the position indicator within an active area AA, the position detecting device includes an X-sensor coil group including X-sensor coils X0, . . . X4 arranged in an X-direction, a switch connected to the X-sensor coil group, and an X-axis TX/RX circuit. The X-axis TX/RX circuit generates an alternating magnetic field (sending-out magnetic field, the same applies hereinafter) by feeding a current through each X-sensor coil of the X-sensor coil group arranged on an X-axis in a sending-out period, and in a detection period after the sending-out period, detects, by current or voltage, an electromotive force generated in each X-sensor coil of the X-sensor coil group by a pen signal (alternating magnetic field generated by the circuit of the position indicator, the same applies hereinafter) continuously generated even after the sending-out period from the position indicator that has stored energy in the resonance circuit in the sending-out period.

Similarly, in order to obtain the coordinate in a Y-axis direction of the position indicator, the position detecting device includes a Y-sensor coil group including Y-sensor coils Y0, . . . Y4 arranged in a Y-direction, a switch connected to the Y-sensor coil group, and a Y-axis TX/RX circuit. The Y-axis TX/RX circuit generates the sending-out magnetic field by feeding a current through each X-sensor coil of the X-sensor coil group arranged on a Y-axis in the sending-out period, and in the detection period after the sending-out period, detects, by current or voltage, an electromotive force generated in each Y-sensor coil of the Y-sensor coil group by the pen signal continuously generated even after the sending-out period from the position indicator that has stored energy in the resonance circuit in the sending-out period.

The position detecting device, for example, selects one sensor coil in predetermined order from a plurality of sensor coils constituting the position detecting sensor, sends out a transmission signal from the selected sensor coil to the position indicator, and thereby charges the capacitor within the position indicator.

On the other hand, the position detecting device connects the sensor coil used for the transmission to a receiving circuit, and receives the signal transmitted from the resonance circuit of the position indicator.

The position detecting device detects the position of the position indicator on the position detecting device by sequentially selecting the sensor coils and performing such signal transmission and reception.

In detecting the position of the position indicator in the position detecting device, first, (1) a global scan that sequentially selects all of the sensor coils and detects a position indicated by the position indicator is performed in order to detect approximately where the position indicator is located on the indicated position detecting sensor, and thereby an approximate position on the position detecting sensor is identified. Then, (2) the position indicated by the position indicator is accurately identified by performing a sector scan that selects only a predetermined number of sensor coils at and in the vicinity of the identified approximate position in order and performs signal transmission and reception.

Here, in the example of FIG. 9, as for the coordinate in the Y-axis direction of the position indicator, as illustrated in RXdata (upper part) in the figure, the coordinate in the Y-direction is derived by an interpolation computation or the like from a distribution of level values in a uniaxial direction such as a level value 34 obtained by the Y-sensor coil Y0, a level value 118 obtained by the Y-sensor coil Y1, . . . , a level value 107 obtained by the Y-sensor coil Y4.

Similarly, as for the coordinate in the X-axis direction of the position indicator, as illustrated in RXdata (lower part) in the figure, the coordinate in the X-direction is derived by an interpolation computation or the like from a distribution of level values in a uniaxial direction such as a level value 25 obtained by the X-sensor coil X0, a level value 100 obtained by the X-sensor coil X1, . . . , a level value 99 obtained by the X-sensor coil X4.

Thus, in obtaining the two-dimensional coordinates of the position indicator, the position detecting device in FIG. 9 separately obtains the level values on each of the two axes, obtains the coordinates in each dimension for each of the X-axis and the Y-axis on the basis of each of the distributions (RXdata), combines these two coordinates, performs certain data processing, and thereafter outputs the result as the two-dimensional coordinates.

In addition, as illustrated in FIG. 10, a stack configuration in a case of combining (or assembling) the position detecting device described above, a touch sensor for detecting a finger or the like by a capacitance (self-capacitance or mutual capacitance) system, and a display device is a configuration provided with a display 300 (including a front panel layer 301 and a TFT (thin film transistor) back panel layer 302). An EM (electromagnetic) sensor is provided on the lower side of the display 300 via a bonding layer (Glue), and the EM sensor includes a TX-sensor coil group 100 and an RX-sensor coil group 200.

Further, in the configuration, the touch sensor is provided on the upper side of the display 300, and a cover glass (including the case of a cover film, the same applies hereinafter) with which the pen comes in contact is provided on the upper side of the touch sensor (see JP2007/157107, for example).

However, with the conventional position detecting device described in JP2007/157107 described above, the touch sensor, the display 300, and the EM sensor (including the TX-sensor coil group and the RX-sensor coil group) are formed in respective different substrates (different layers). Thus, a stack structure obtained by joining these together by bonding layers has a large thickness, and designability of the position detecting device is impaired.

### BRIEF SUMMARY

Accordingly, the present disclosure has been made in view of the above-described problems, and it is an object of the present disclosure to provide a position detecting device improved in designability by thinning the stack structure while maintaining the performance of the position detecting device and a display device including the position detecting device.

Mode 1: one or more embodiments of the present disclosure propose a position detecting device for detecting a position of a pen by using electromagnetic induction action. The position detecting device includes a first electrode layer provided with a first electrode configured to generate an alternating magnetic field, a display layer configured to control display pixels and blinking of the display pixels, and a second electrode layer provided with a plurality of second electrodes configured to detect a pen alternating magnetic field generated by the pen that has stored energy by the alternating magnetic field, where the second electrode layer is on an opposite side of the display layer from a side provided with the first electrode layer.

Mode 2: one or more embodiments of the present disclosure propose a position detecting device for detecting a position of a pen by using electromagnetic induction action. The position detecting device includes a first electrode layer provided with a first electrode configured to generate an alternating magnetic field and a second electrode layer provided with a plurality of second electrodes configured to detect a pen alternating magnetic field generated by the pen that has stored energy by the alternating magnetic field. The second electrode layer is formed on a side of a substrate.

Mode 3: one or more embodiments of the present disclosure propose a display device for use in a position detecting device for detecting a position of a pen by using electromagnetic induction action. The display device includes a display front panel, a TFT back panel provided to a lower surface of the display front panel, the TFT back panel being mounted with TFTs configured to drive display pixel electrodes of a display, and a touch panel provided on an upper portion of the display front panel. There is at least either a first electrode layer or a second electrode layer provided in the TFT back panel or the touch panel. The first electrode layer is provided with a first electrode configured to generate an alternating magnetic field, and the second electrode layer is provided with a plurality of second electrodes configured to detect a pen alternating magnetic field generated by the pen that has stored energy by the alternating magnetic field.

One or more embodiments of the present disclosure produce an effect of being able to thin a stack structure and improve designability while maintaining the performance of a position detecting device.

### BRIEF DESCRIPTION OF THE SEVERAL VIEWS OF THE DRAWINGS

FIG. 1 is a conceptual diagram illustrating a coordinate deriving operation of a position detecting device according to a first embodiment of the present disclosure;

FIG. 2 is a conceptual diagram illustrating a coordinate deriving operation in a modification of the position detecting device according to the first embodiment of the present disclosure;

FIG. 3A is a diagram illustrating an example of a stack configuration in a case of combining (or assembling) the position detecting device according to the first embodiment of the present disclosure, a touch sensor for detecting a finger or the like by a capacitance (self-capacitance or mutual capacitance) system, and a display layer;

FIG. 3B is a diagram illustrating an example of the stack configuration in the case of combining (or assembling) the position detecting device according to the first embodiment of the present disclosure, the touch sensor for detecting a finger or the like by the capacitance (self-capacitance or mutual capacitance) system, and the display layer;

FIG. 4 is a diagram illustrating an example of a configuration of a first sensor coil group in the position detecting device according to the first embodiment of the present disclosure;

FIG. 5 is a diagram illustrating an example of a configuration of a second sensor coil group in the position detecting device according to the first embodiment of the present disclosure;

FIG. 6A is a diagram illustrating an example of a stack configuration in a case of combining (or assembling) a position detecting device according to a second embodiment of the present disclosure, a touch sensor for detecting a finger or the like by the capacitance (self-capacitance or mutual capacitance) system, and a display layer;

FIG. 6B is a diagram illustrating an example of the stack configuration in the case of combining (or assembling) the position detecting device according to the second embodiment of the present disclosure, the touch sensor for detecting a finger or the like by the capacitance (self-capacitance or mutual capacitance) system, and the display layer;

FIG. 6C is a diagram illustrating an example of the stack configuration in the case of combining (or assembling) the position detecting device according to the second embodiment of the present disclosure, the touch sensor for detecting a finger or the like by the capacitance (self-capacitance or mutual capacitance) system, and the display layer;

FIG. 6D is a diagram illustrating an example of the stack configuration in the case of combining (or assembling) the position detecting device according to the second embodiment of the present disclosure, the touch sensor for detecting a finger or the like by the capacitance (self-capacitance or mutual capacitance) system, and the display layer;

FIG. 6E is a diagram illustrating an example of the stack configuration in the case of combining (or assembling) the position detecting device according to the second embodiment of the present disclosure, the touch sensor for detecting a finger or the like by the capacitance (self-capacitance or mutual capacitance) system, and the display layer;

FIG. 6F is a diagram illustrating an example of the stack configuration in the case of combining (or assembling) the position detecting device according to the second embodiment of the present disclosure, the touch sensor for detecting a finger or the like by the capacitance (self-capacitance or mutual capacitance) system, and the display layer;

FIG. 7A is a diagram illustrating an example of a configuration of a first sensor coil group in the position detecting device according to the second embodiment of the present disclosure;

FIG. 7B is a diagram illustrating an example of the configuration of the first sensor coil group in the position detecting device according to the second embodiment of the present disclosure;

FIG. 8A is a diagram illustrating an example of a stack configuration in a case of combining (or assembling) a position detecting device according to a third embodiment of the present disclosure, a touch sensor for detecting a finger or the like by the capacitance (self-capacitance or mutual capacitance) system, and a display layer;

FIG. 8B is a diagram illustrating an example of the stack configuration in the case of combining (or assembling) the position detecting device according to the third embodiment of the present disclosure, the touch sensor for detecting a finger or the like by the capacitance (self-capacitance or mutual capacitance) system, and the display layer;

FIG. 9 is a conceptual diagram illustrating a coordinate deriving operation of a position detecting device according to a conventional example; and

FIG. 10 is a diagram illustrating a conventional stack configuration in a case of combining (or assembling) the position detecting device according to the conventional example, a touch sensor for detecting a finger or the like by the capacitance (self-capacitance or mutual capacitance) system, and a display layer.

### DETAILED DESCRIPTION

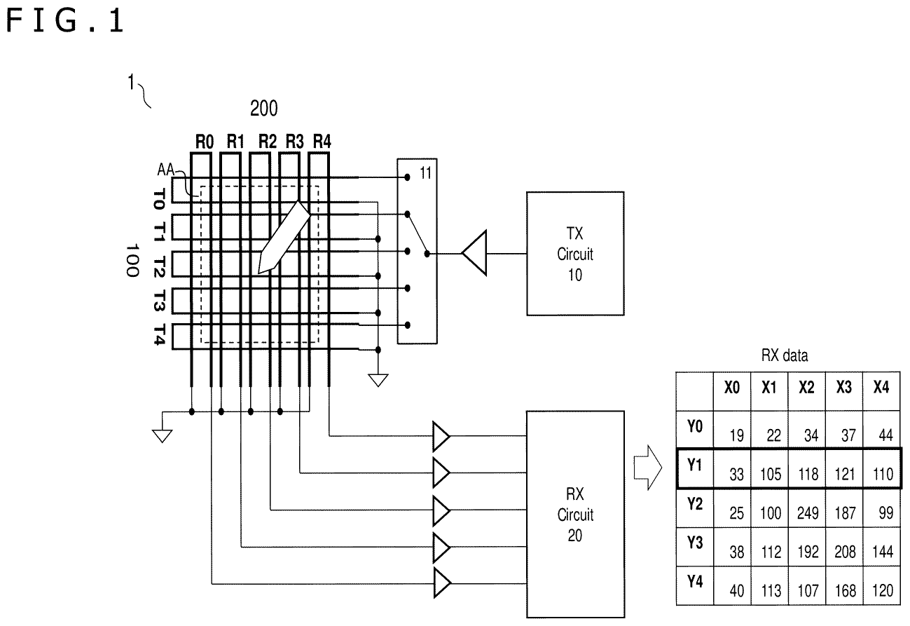

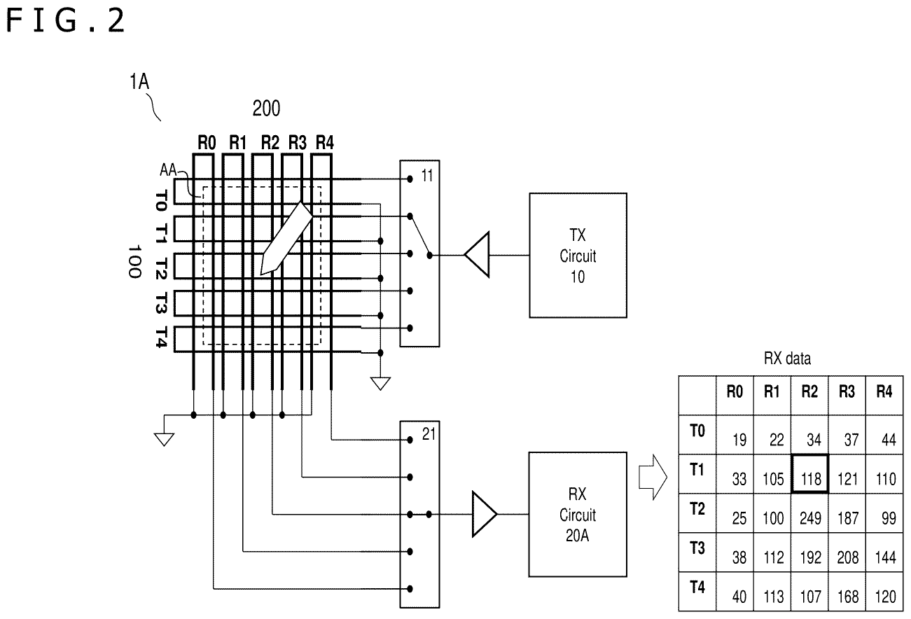

Embodiments of the present disclosure will hereinafter be described with reference to FIGS. 1 to 8B.

### First Embodiment

A position detecting device 1 according to the present embodiment will be described with reference to FIGS. 1 to 5.

### Configuration of Position Detecting Device 1

As illustrated in FIG. 1, the position detecting device 1 includes a first circuit 10, a switch 11, a first sensor coil group 100, a second sensor coil group 200, a second circuit 20, and a peripheral circuit such as an amplifier.

The first sensor coil group 100 is a plurality of conducting wires having a plurality of electrodes arranged in parallel with each other in a first direction (X-axis direction) of the sensor. First sensor coils constituting the first sensor coil group 100 are formed by rectangular loop coils, for example. The first sensor coils constituting the first sensor coil group 100 are arranged side by side at equal intervals, for example.

The second sensor coil group 200 is a plurality of conducting wires having a plurality of electrodes arranged in parallel with each other in a second direction (Y-axis direction) intersecting the first direction (X-axis direction). Second sensor coils constituting the second sensor coil group 200 are formed by rectangular loop coils, for example. The second sensor coils constituting the second sensor coil group 200 are arranged side by side at equal intervals, for example.

The first circuit 10 functions as an alternating magnetic field generator that transmits a signal to the first sensor coil group 100 via the switch 11, and thereby makes an alternating magnetic field generated from the first sensor coil group 100. That is, in the position detecting device 1 according to the present embodiment, the first sensor coils T0, T1, , , . , T4 are connected to the first circuit 10 and used to generate the alternating magnetic field, but is not used to detect a pen signal.

The second circuit 20 functions as a pen signal level receiver that receives the pen signal as a response alternating magnetic field from a position indicator stored according to the alternating magnetic field and obtains the level of the pen signal by using the plurality of electrodes of the second sensor coil group 200. Specifically, the second circuit 20, for example, derives the coordinates of a pen or the like at cross points at which the plurality of electrodes (first electrodes) arranged in parallel with each other in the first direction (X-axis direction) of the sensor and the plurality of electrodes (second electrodes) arranged in parallel with each other in the second direction (Y-axis direction) intersecting the first direction (X-axis direction), for example, intersect one another. That is, the second sensor coils R0, R1, . . . , R4 are connected to the second circuit 20 and used to detect the pen signal, but are not used to generate the sending-out magnetic field.

The second circuit 20 functions as an information deriving circuitry that derives information regarding the position of the position indicator by using a two-dimensional distribution of the level of the pen signal at each of points of intersection of the plurality of conducting wires of the first sensor coil group 100 and the plurality of electrodes of the second sensor coil group 200. Here, the information regarding the position of the pen (position indicator) includes either the inclination of the pen with respect to a normal to a sensor plane (XY plane formed by an X-axis and a Y-axis) or the direction of the inclination of the pen with respect to the sensor plane.

The information deriving circuitry of the second circuit 20 derives either the inclination of the pen with respect to the normal to the sensor plane or the direction of the inclination of the pen with respect to the sensor plane on the basis of the asymmetry of the two-dimensional distribution. The information deriving circuitry of the second circuit 20 obtains a first reference position as a position indicated by a pen tip of the pen, obtains an upwardly protruding or downwardly protruding second reference position, and derives the direction of the inclination of the pen with respect to the sensor plane on the basis of the direction of the second reference position with respect to the first reference position. The information deriving circuitry of the second circuit 20 derives the inclination of the pen with respect to the normal to the sensor plane on the basis of the level strength of the pen signal at the first reference position and the level strength of the pen signal at the second reference position.

### Processing of Position Detecting Device 1

The position detecting device 1 selects, by using the switch 11, one first sensor coil of the first sensor coil group 100 for generating the sending-out magnetic field and sends out the sending-out magnetic field by driving the selected first sensor coil by the first circuit 10.

FIG. 1 illustrates a state in which the first sensor coil T1 is selected.

After a certain sending-out period, that is, after a period in which predetermined energy will be stored in the pen when the pen is present in the vicinity of the first sensor coil, the position detecting device 1 obtains the level of the pen signal at the positions of all the second sensor coils. The position detecting device 1 detects level values of the pen signal (33, 105, 118, 121, and 110 in the figure) in regions in which the first sensor coil T1 crosses the second sensor coils R1, R2, . . . , R4 (which regions will hereinafter be referred to as coil cross point regions).

The position detecting device 1 obtains signal levels at respective coil cross points, that is, two-dimensional heat map data RXdata, by sequentially changing the selection of the first sensor coil. After obtaining the two-dimensional heat map data RXdata, the position detecting device 1 performs a process in coordinate processing and thereby obtains the coordinates of the pen and the inclination of the pen (angle from the normal to the sensor surface) or the orientation of the pen (inclining direction) on the basis of the two-dimensional heat map data RXdata.

### First Stack Configuration of Position Detecting Device 1

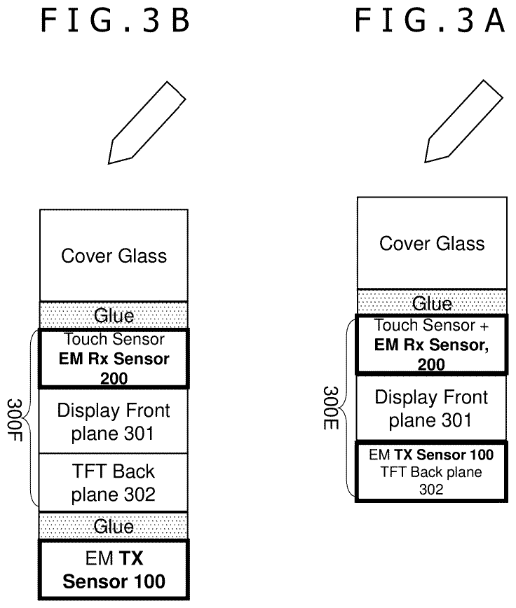

A first stack configuration of the position detecting device 1 illustrated in FIG. 3A is a configuration including a first electrode layer (first sensor coil group 100) provided with the first electrodes that generate the alternating magnetic field, a display layer 301 that controls display pixels and the blinking of the display pixels, and a second electrode layer (second sensor coil group 200) provided with the plurality of second electrodes that detect a pen alternating magnetic field generated by the pen that has stored energy by the alternating magnetic field. The second electrode layer is on an opposite side of the display layer 301 from a side provided with the first electrode layer (first sensor coil group 100). That is, the first stack configuration of the position detecting device 1 illustrated in FIG. 3A is a configuration in which the first electrode layer (first sensor coil group 100) and the second electrode layer (second sensor coil group 200) are provided in different layers separated from each other.

The second electrode layer (second sensor coil group 200) is formed on a side of a mounted substrate and is provided with the plurality of second electrodes by using transparent electrodes on a side closer to the pen than the display layer 301. In addition, the first electrode layer (first sensor coil group 100) is formed on a side of the mounted substrate.

As illustrated in FIG. 3A, in the first stack configuration of the position detecting device 1, a display 300E is formed by providing the first electrode layer (first sensor coil group 100) in a TFT back panel layer 302 and providing the second electrode layer (second sensor coil group 200) in a layer on the upper side of the display layer 301 provided with an on-cell touch sensor (capacitive sensor). A cover glass is bonded above the display layer 301 by an adhesive or the like.

Incidentally, in the case of the present configuration, the layer in which the touch sensor of a capacitive type and the second electrode layer (second sensor coil group 200) are integrated with each other is provided on the upper side of the display layer 301.

Therefore, in order not to impair the visibility of the display 300E, the second electrode layer (second sensor coil group 200) includes transparent electrodes for which a material combining a high electric conductivity and a high visible light transmissivity (transparent conductor) is used. Incidentally, a magnetic shield plate may be provided to the lower side of the first electrode layer (first sensor coil group 100).

### Second Stack Configuration of Position Detecting Device 1

As illustrated in FIG. 3B, a second stack configuration of the position detecting device 1 is formed by providing the first electrode layer (first sensor coil group 100) on the lower side of the display layer 301 without the first electrode layer (first sensor coil group 100) being provided in the TFT back panel layer 302, by providing the second electrode layer (second sensor coil group 200) together with the touch sensor in a layer on the upper side of the display layer 301 with the on-cell touch sensor (capacitive sensor), and by providing a cover glass on the upper side of the layer. That is, the second stack configuration of the position detecting device 1 illustrated in FIG. 3B is a configuration in which the first electrode layer (first sensor coil group 100) and the second electrode layer (second sensor coil group 200) are provided in different layers separated from each other.

The second electrode layer (second sensor coil group 200) is formed on a side of a mounted substrate. The second electrode layer (second sensor coil group 200) is provided with the plurality of second electrodes by using transparent electrodes on a side closer to the pen than the display layer 301. The first electrode layer (first sensor coil group 100) is formed on a side of the mounted substrate.

Incidentally, in the case of the present configuration, the layer in which the touch sensor of the capacitive type and the second electrode layer (second sensor coil group 200) are integrated with each other is provided on the upper side of the display layer 301. Therefore, in order not to impair the visibility of a display 300F, the second electrode layer (second sensor coil group 200) includes transparent electrodes for which a material combining a high electric conductivity and a high visible light transmissivity (transparent conductor) is used. Incidentally, a magnetic shield plate may be provided to the lower side of the first electrode layer (first sensor coil group 100).

### Configuration of First Electrode Layer (First Sensor Coil Group 100)

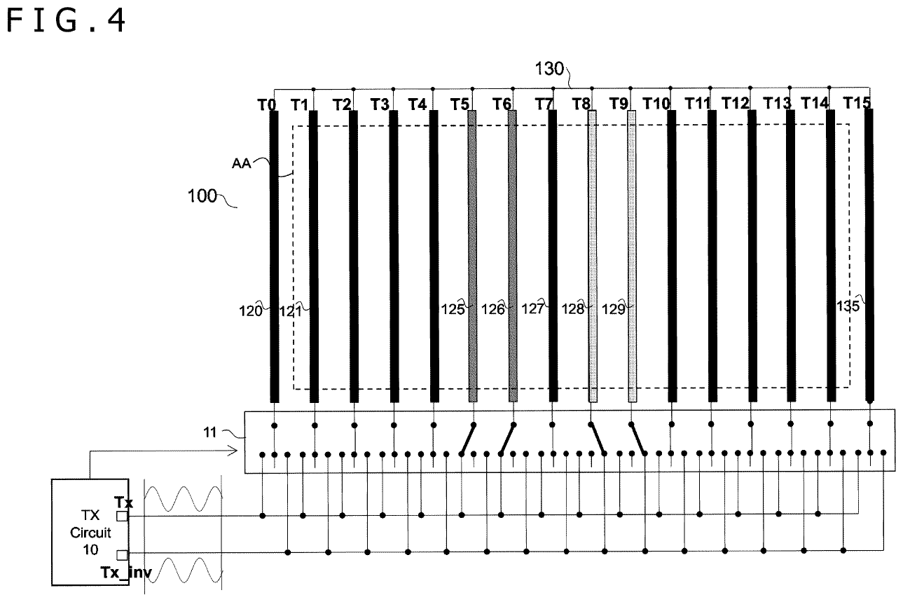

FIG. 4 is a diagram illustrating an example of a configuration of the first electrode layer (first sensor coil group 100).

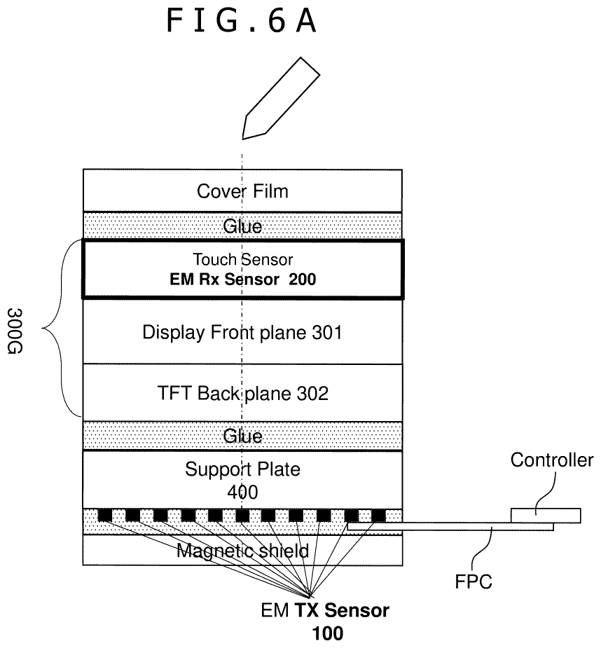

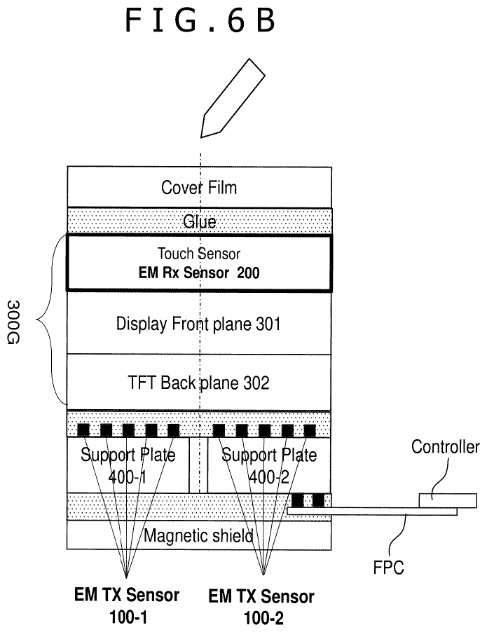

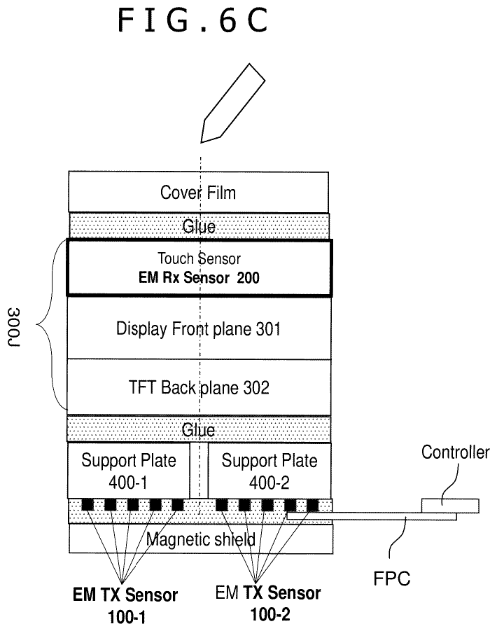

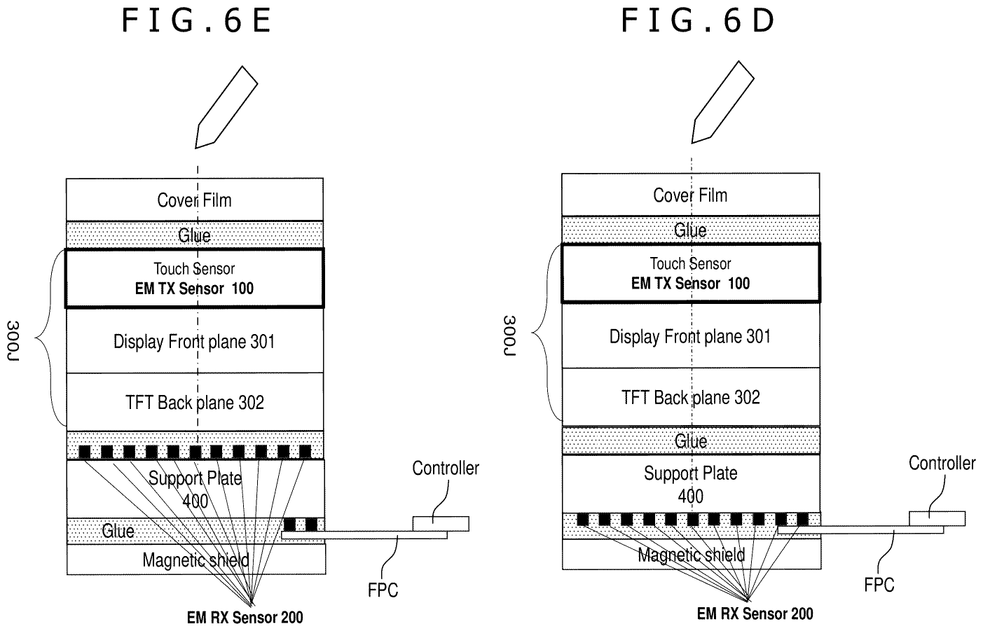

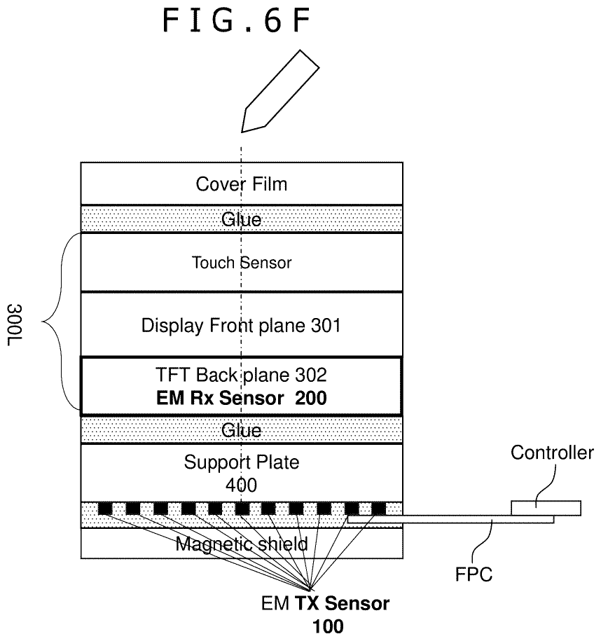

The configuration of the first electrode layer (first sensor coil group 100) in the figure is effective particularly in a case where the first electrode layer (first sensor coil group 100) and the second electrodes (second sensor coil group 200) are provided in separate layers and are formed as single layers, as illustrated in FIG. 3A, FIG. 3B, and FIGS. 6A to 6F, for example, in which the first electrode layer (first sensor coil group 100) and the second electrode (second sensor coil group 200) in particular are provided in different layers separated from each other.

The first electrode layer (first sensor coil group 100) is formed on a side of the substrate. As illustrated in FIG. 4, the first electrode layer (first sensor coil group 100) includes a first electrode 120, . . . , a first electrode 135 respectively constituting first sensor coils T0, T1, . . . , T15 and a connecting conductor 130 as a second connector that connects the first electrodes 120 to 135 to one another. The first electrode layer (first sensor coil group 100) is thereby formed in the form of a comb shape (saw shape).

The position detecting device 1 controls the switch 11 to, for example, bundle the first electrode 125 and the first electrode 126 and connect the first electrode 125 and the first electrode 126 to a first terminal of the first circuit 10, while bundling the first electrode 128 and the first electrode 129 and connecting the first electrode 128 and the first electrode 129 to a first_inv terminal of the first circuit 10.

The first circuit 10 performs control such that current change amounts of the first terminal and the first_inv terminal are in opposite phases from each other. The first circuit 10 thereby forms a strong sending-out magnetic field between the bundle of the first electrode 125 and the first electrode 126 and the bundle of the first electrode 128 and the first electrode 129 (in the vicinity of the first electrode 127) as compared with a case where no bundles are made or where the first_inv terminal is set at a fixed potential.

Incidentally, the switch 11 and the first circuit 10 may be mounted on separate integrated circuits, or may be integrated on a same integrated circuit.

### Configuration of Second Electrode Layer (Second Sensor Coil Group 200)

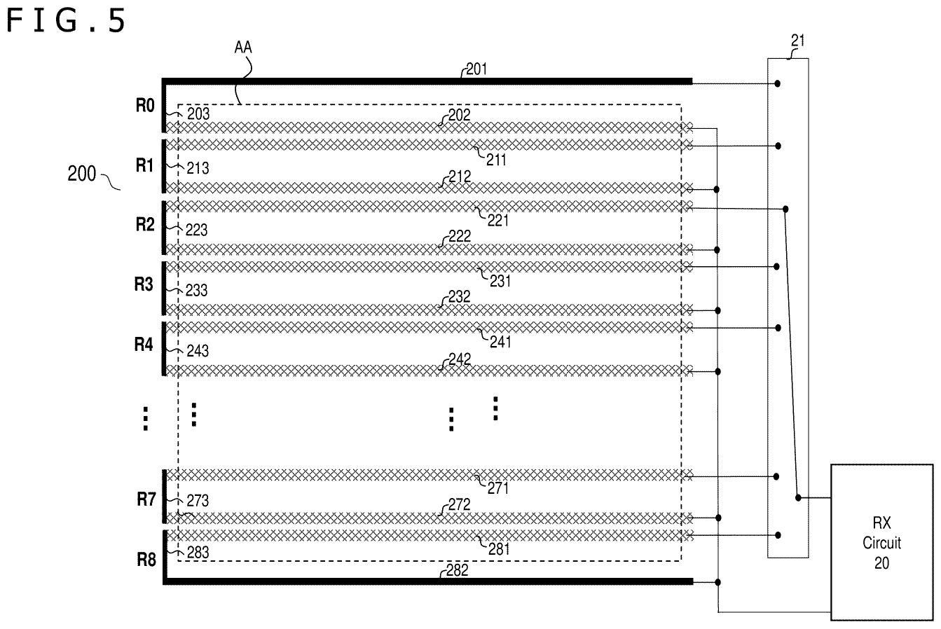

FIG. 5 illustrates an example of a configuration of the second electrode layer (second sensor coil group 200).

The second electrode layer (second sensor coil group 200) in the figure is a sensor to be used in a case where the second electrode layer (second sensor coil group 200) is formed on the upper side of the display (side closer to the pen). The second electrode layer (second sensor coil group 200) includes second sensor coils R0 to R8 and is substantially transparent within an active area AA, constituted by only one side of a film, has a gap between adjacent second coil sensors without the adjacent second coil sensors overlapping each other, and has one-turn winding (not wound a plurality of turns).

As illustrated in FIG. 5, the coil shape of the second electrode layer (second sensor coil group 200) is formed by mesh electrodes having a repetition of a predetermined local pattern, for example. In addition, the mesh electrodes are formed by linearly arranging two mesh portions (AA long side portions 202, 211, 212, 221, 222, 231, 232, 241, 242, . . . , 271, 272, and 281) in parallel with each other. The two mesh portions have a predetermined space (gap) therebetween.

As illustrated in FIG. 5, connecting conductors 203, 213, 223, 233, 243, . . . , 273, and 283 as first connectors that do not have a mesh structure are included on the outside of the active area AA of the second electrode layer (second sensor coil group 200). The connecting conductors connect a mesh portion (for example, 211) on the lower side in the extending direction of the first electrodes among the two mesh portions of each of the mesh electrodes and a mesh portion (for example, 212) on the upper side in the extending direction of the first electrodes among the two mesh portions (AA long side portions 202, 211, 212, 221, 222, 231, 232, 241, 242, . . . , 271, 272, and 281) of each of the mesh electrode that are adjacent to each other with a predetermined interval therebetween.

As illustrated in FIG. 5, coupling portions (for example, 201 and 282) that extend in the same direction as the second electrodes and do not have a mesh structure are included on the outside of the active area AA of the second electrode layer (second sensor coil group 200). The coupling portions are coupled to connecting conductors (for example, 203 and 283) as first connectors connected to a mesh portion (for example, 202) on the upper side in the extending direction of the first electrodes or a mesh portion (for example, the AA long side portion 281) on the lower side in the extending direction of the first electrodes among the two mesh portions (AA long side portions 202 and 281) of each of mesh electrodes at edges of the active area AA.

Specifically, as illustrated in FIG. 5, the second sensor coil R0 located at an outermost edge is constituted by the outside-AA long side portion 201 as an opaque metallic conductor disposed outside the active area AA, not having a mesh structure, the AA long side portion (mesh portion 202) as a substantially transparent conductor (typically a mesh conductor) disposed inside the active area AA, and the connecting conductor 203 as an opaque metallic conductor disposed outside the active area AA, not having a mesh structure.

In addition, similarly, the second sensor coil R8 located at another outermost edge is constituted by the outside-AA long side portion 282 as an opaque metallic conductor disposed outside the active area AA, not having a mesh structure, the AA long side portion 281 as a substantially transparent conductor (typically a mesh conductor) disposed inside the active area AA, and the connecting conductor 283 as a first connector that is an opaque metallic conductor disposed outside the active area AA, not having a mesh structure.

In addition, the second sensor coil R1 located inside the outermost edges is constituted by the AA long side portion 211 and the AA long side portion 212 as substantially transparent conductors (typically mesh conductors) disposed inside the active area AA and the connecting conductor 213 as an opaque metallic conductor disposed outside the active area AA, not having a mesh structure. The connecting conductor 213 connects the AA long side portions 211 and 212 to each other.

In addition, similarly, the second sensor coils R2 to R7 located inside the outermost edges are each constituted by two AA long side portions (221 and 222 or the like) as substantially transparent conductors (typically mesh conductors) disposed inside the active area AA and a connecting conductor (223 or the like) as an opaque metallic conductor disposed outside the active area AA, not having a mesh structure. The connecting conductor connects the two AA long side portions to each other.

One end of each of the second sensor coils of the second electrode layer (second sensor coil group 200) is connected to the second circuit 20 via a switch 21. Another end of each of the second sensor coils is connected to a reference potential such as GND.

Incidentally, in a case where a differential amplifier circuit is provided in the second circuit 20, the one end and the other end of each of the second sensor coils of the second electrode layer (second sensor coil group 200) may be connected to input terminals of the differential amplifier circuit.

In addition, in the second electrode layer (second sensor coil group 200), a part, other than a part where the coil shape is formed on a side of the substrate, is provided with a dummy pattern obtained by repeating a pattern having a similar visibility to that of the mesh pattern of the mesh portions (AA long side portions 202, 211, 212, 221, 222, 231, 232, 241, 242, . . . , 271, 272, and 281).

### Actions and Effects

The position detecting device 1 according to the present embodiment includes the first electrode layer (first sensor coil group 100) provided with the first electrodes that generate the alternating magnetic field, the display layer 301 that controls the display pixels and the blinking of the display pixels, and the second electrode layer (second sensor coil group 200) provided with the plurality of second electrodes that detect the pen alternating magnetic field generated by the pen that has stored energy by the alternating magnetic field. The second electrode layer is on the opposite side of the display layer 301 from the side provided with the first electrode layer. That is, the position detecting device 1 according to the present embodiment has a configuration in which the first electrode layer (first sensor coil group 100) and the second electrode layer (second sensor coil group 200) are provided in different layers separated from each other.

Therefore, by providing the second electrode layer (second sensor coil group 200) operating with a smaller current than the first electrode layer (first sensor coil group 100) in a layer on the upper side of the display layer 301 provided with the on-cell touch sensor (capacitive sensor) and providing the first electrode layer (first sensor coil group 100) in a layer on the lower side of the display layer 301, as illustrated in FIG. 3A, it is possible to thin the stack structure and improve designability while maintaining the performance of the position detecting device without practically impairing the visibility of the display 300E.

As illustrated in FIG. 3B, the position detecting device 1 according to the present embodiment is formed by providing the first electrode layer (first sensor coil group 100) on the lower side of the display layer 301 without the first electrode layer (first sensor coil group 100) being provided in the TFT back panel layer 302, providing the second electrode layer (second sensor coil group 200) together with the touch sensor in a layer on the upper side of the display layer 301 provided with the on-cell touch sensor (capacitive sensor), and providing a cover glass on the upper side of the layer.

That is, the position detecting device 1 according to the present embodiment has a configuration in which the first electrode layer (first sensor coil group 100) and the second electrode layer (second sensor coil group 200) are provided in different layers separated from each other.

Therefore, by providing the second electrode layer (second sensor coil group 200) operating with a smaller current than the first electrode layer (first sensor coil group 100) in a layer on the upper side of the display front panel layer 301 provided with the on-cell touch sensor (capacitive sensor) and providing the first electrode layer (first sensor coil group 100) on the lower side of the display layer 301, as illustrated in FIG. 3B, it is possible to thin the stack structure and improve designability while maintaining the performance of the position detecting device without practically impairing the visibility of the display 300F.

In the position detecting device 1 according to the present embodiment, the first electrode layer (first sensor coil group 100) is formed a side of the substrate. That is, the first electrode layer (first sensor coil group 100) is formed as one layer. Therefore, this contributes to thinning the stack structure and improving designability.

In the position detecting device 1 according to the present embodiment, the first electrode 120, . . . , the first electrode 135 respectively constituting the first sensor coils T0, T1, . . . , T15 and the connecting conductor 130 as the second connector that connects the first electrodes 120 to 135 to one another are included so as to be formed in the form of a comb shape (saw shape). That is, by controlling the switch 11, the position detecting device 1 according to the present embodiment, for example, bundles the first electrode 125 and the first electrode 126 and connects the first electrode 125 and the first electrode 126 to the first terminal of the first circuit 10, while bundling the first electrode 128 and the first electrode 129 and connecting the first electrode 128 and the first electrode 129 to the first_inv terminal of the first circuit 10.

In addition, the first circuit 10 performs control such that current change amounts of the first terminal and the first_inv terminal are in opposite phases from each other. A strong sending-out magnetic field can be thereby formed between the bundle of the first electrode 125 and the first electrode 126 and the bundle of the first electrode 128 and the first electrode 129 (in the vicinity of the first electrode 127) as compared with a case where no bundles are made or where the first_inv terminal is set at a fixed potential. In other words, by bundling pluralities of first electrodes, it is possible to form a sending-out magnetic field of a desired strength even when the first electrode layer (first sensor coil group 100) is formed by the first electrodes originally small in line width and thus high in impedance.

In the position detecting device 1 according to the present embodiment, the second electrode layer (second sensor coil group 200) is formed on a side of the mounted substrate. That is, the second electrode layer (second sensor coil group 200) is formed as one layer. Therefore, this contributes to thinning the stack structure and improving designability.

In the position detecting device 1 according to the present embodiment, the second electrode layer (second sensor coil group 200) is provided with the plurality of second electrodes by using transparent electrodes on a side closer to the pen than the display layer 301. It is therefore possible to thin the stack structure and improve designability while maintaining the performance of the position detecting device without impairing the visibility of the displays 300E and 300F.

In the position detecting device 1 according to the present embodiment, the second electrode layer (second sensor coil group 200) has a gap between adjacent second coil sensors without the adjacent second coil sensors overlapping each other and has one-turn winding (is not wound a plurality of turns). Therefore, the second electrode layer (second sensor coil group 200) can be formed as one layer. Hence, this contributes to thinning the stack structure and improving designability.

In the position detecting device 1 according to the present embodiment, the coil shape of the second electrode layer (second sensor coil group 200) is formed by mesh electrodes having a repetition of a predetermined local pattern. The second electrode layer (second sensor coil group 200) can therefore improve transparency. It is thus possible to thin the stack structure and improve designability while maintaining the performance of the position detecting device without impairing the visibility of the displays 300E and 300F.

In the position detecting device 1 according to the present embodiment, mesh electrodes of the second electrode layer (second sensor coil group 200) are formed by linearly arranging two mesh portions (AA long side portions 202, 211, 212, 221, 222, 231, 232, 241, 242, . . . , 271, 272, and 281) in parallel with each other, where the two mesh portions have a predetermined space (gap) therebetween. That is, the second electrode layer (second sensor coil group 200) has a gap between adjacent second coil sensors without the adjacent second coil sensors overlapping each other and has one-turn winding (is not wound a plurality of turns). Therefore, the second electrode layer (second sensor coil group 200) can be formed as one layer. Hence, this contributes to thinning the stack structure and improving designability.

In the position detecting device 1 according to the present embodiment, the connecting conductors 203, 213, 223, 233, 243, . . . , 273, and 283 as the first connectors that do not have a mesh structure are included on the outside of the active area AA of the second electrode layer (second sensor coil group 200). The connecting conductors connect a mesh portion (for example, the AA long side portion 211) on the lower side in the extending direction of the first electrodes among two mesh portions of each of the mesh electrodes and a mesh portion (for example, 212) on the upper side in the extending direction of the first electrodes among mesh portions (AA long side portions 202, 211, 212, 221, 222, 231, 232, 241, 242, . . . , 271, 272, and 281) of mesh electrodes that are adjacent to each other with a predetermined interval therebetween.

That is, a one-turn rectangular loop coil is formed by connecting a mesh portion (for example, the AA long side portion 211) on the lower side in the extending direction of the first electrodes among two mesh portions of each of the mesh electrodes to a mesh portion (for example, 212) adjacent thereto with a predetermined interval on the upper side in the extending direction of the first electrodes by the connecting conductor 203, 213, 223, 233, 243, . . . , 273, or 283 as a first connector. In addition, the connecting conductors 203, 213, 223, 233, 243, . . . , 273, and 283 as the first connectors are provided outside the active area AA, and thus do not have a mesh structure. The second electrode layer (second sensor coil group 200) can therefore thin the stack structure and improve designability while maintaining the performance of the position detecting device and reducing cost without impairing the visibility of the display.

In the position detecting device 1 according to the present embodiment, the coupling portions (for example, 201 and 282) that extend in the same direction as the second electrodes of the mesh portions (AA long side portions 202, 211, 212, 221, 222, 231, 232, 241, 242, . . . , 271, 272, and 281) and do not have a mesh structure are included on the outside of the active area AA of the second electrode layer (second sensor coil group 200). The coupling portions are coupled to the connecting conductors (for example, 203 and 283) as the first connectors connected to a mesh portion (for example, 202) on the upper side in the extending direction of the first electrodes or a mesh portion (for example, the AA long side portion 281) on the lower side in the extending direction of the first electrodes among the two mesh portions (AA long side portions 202 and 281) of each of the mesh electrodes at edges of the active area AA.

That is, the two mesh portions (AA long side portions 202 and 281) of each of the mesh electrodes at the edges of the active area AA form one-turn rectangular loop coils with the connecting conductors (for example, 203 and 283) as the first connectors connected to the mesh portion (for example, 202) on the upper side in the extending direction of the first electrodes or the mesh portion (for example, the AA long side portion 281) on the lower side in the extending direction of the first electrodes and to the coupling portions (for example, 201 and 282) that extend in the same direction as the second electrodes of the mesh portion (for example, the AA long side portion 211) on the lower side in the extending direction of the first electrodes among the two mesh portions of each of the mesh electrodes. The mesh portions (AA long side portions 202, 211, 212, 221, 222, 231, 232, 241, 242, . . . , 271, 272, and 281) do not have a mesh structure. In addition, the coupling portions (for example, 201 and 282) are provided outside the active area AA, and thus do not have a mesh structure.

The second electrode layer (second sensor coil group 200) can therefore thin the stack structure and improve designability while maintaining the performance of the position detecting device and reducing cost without impairing the visibility of the display.

In the position detecting device 1 according to the present embodiment, a part, other than a part where the coil shape is formed in the second electrode layer (second sensor coil group 200) on a side of the substrate, is provided with a dummy pattern obtained by repeating a pattern having a similar visibility to that of the mesh pattern of the mesh portions (AA long side portions 202, 211, 212, 221, 222, 231, 232, 241, 242, . . . , 271, 272, and 281). That is, the whole of the second electrode layer (second sensor coil group 200) is in a pattern having a similar visibility to that of the mesh pattern of the mesh portions (AA long side portions 202, 211, 212, 221, 222, 231, 232, 241, 242, . . . , 271, 272, and 281). It is therefore possible to improve the visibility of the display by suppressing interference fringes (moire) that can be a problem in a case of a geometric configuration in which a plurality of loop coils are arranged.

### Second Embodiment

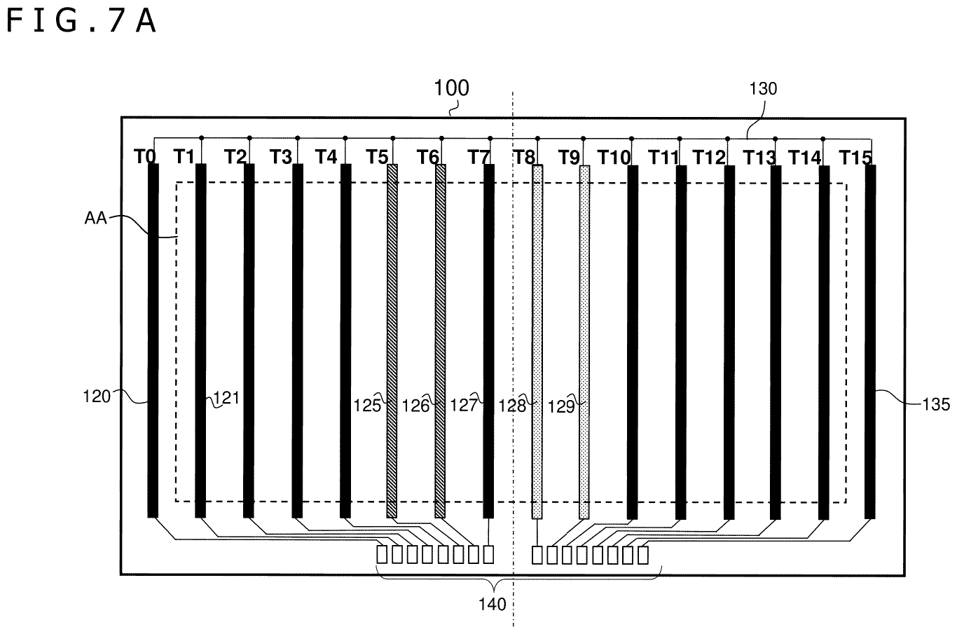

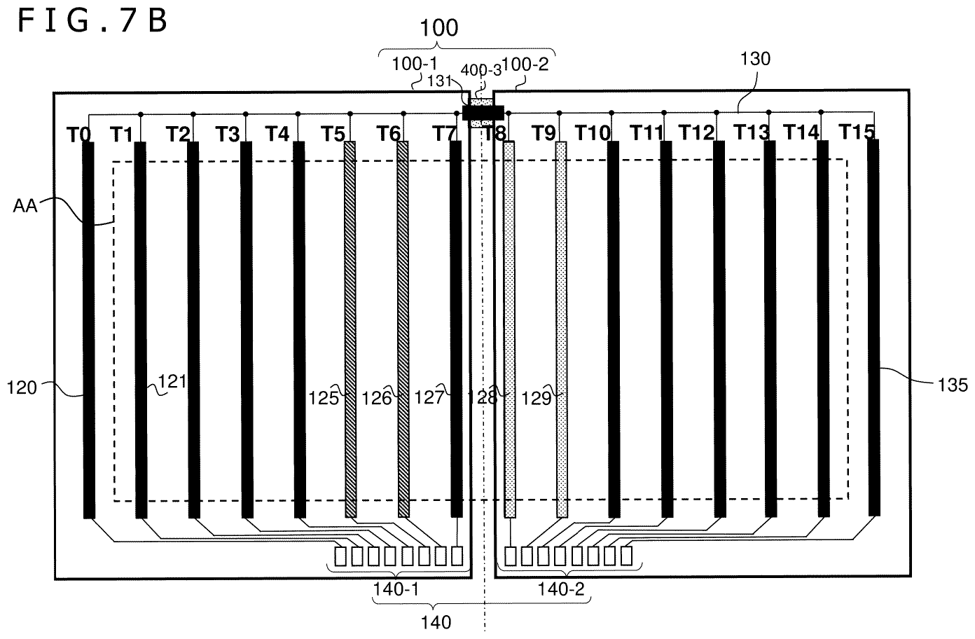

A position detecting device 2 according to the present embodiment will be described with reference to FIGS. 6A to 7B.

Incidentally, a basic configuration of the position detecting device 2 and the configuration of the second electrode layer (second sensor coil group 200) are similar to those of the first embodiment, and therefore detailed description thereof will be omitted.

### First Stack Configuration of Position Detecting Device 2

FIG. 6A illustrates a stack configuration including a flexible display capable of being folded about a folding axis indicated by alternate long and short dashed lines in the figure in a direction in which upper side surfaces of the cover film approach each other (valley fold direction).

As illustrated in FIG. 6A, in the first stack configuration of the position detecting device 2, the display layer 301 has what is called an on-cell touch sensor (capacitive sensor) with a layer on the upper side of the display front panel layer 301 provided with the touch sensor, and is provided with the second electrode layer (second sensor coil group 200). That is, the first stack configuration of the position detecting device 2 illustrated in FIG. 6A is a configuration in which the first electrode layer (first sensor coil group 100) and the second electrode layer (second sensor coil group 200) are provided in different layers separated from each other.

The second electrode layer (second sensor coil group 200) is formed on a side of a mounted substrate. The second electrode layer (second sensor coil group 200) is formed by arranging the plurality of second electrodes by using transparent electrodes on a side closer to the pen than the display layer 301. In addition, the first electrode layer (first sensor coil group 100) is formed on a lower surface of a mounted support plate 400 with respect to the pen.

Further, a connector terminal on an FPC (flexible printed circuit) side is compression-bonded to a pad group of the first electrode layer (first sensor coil group 100) formed on the lower surface of the support plate 400 with respect to the pen, and a controller is connected to the pad group via an FPC.

Here, the display layer 301 is provided with the support plate 400 for protecting the flexible display from impacts. Such a support plate is illustrated as a “plate” in US2023/0071229A1 (FIG. 7), for example.

As illustrated in US2023/0071229A1, the support plate 400 may be a member separated by, for example, providing “grooves” as described in the patent document around the folding axis, or may be one partly or wholly continuous member.

In addition, the support plate 400 is illustrated as a “supporter” in US 2021/0208709A1. For the support plate 400, those illustrated in these documents or the like may be used as appropriate.

As illustrated in FIG. 6A, the first electrode layer (first sensor coil group 100) is directly provided to the lower surface of the support plate 400. Preferably, the support plate 400 is a rigid substrate that is formed of a material having a low conductivity so as not to affect electromagnetic induction and has rigidity such as a glass epoxy substrate (FR4 or the like). The first electrode layer (first sensor coil group 100) is provided by mounting a conductive material such as copper or silver onto a surface (surface on the lower side in FIG. 6A) of the support plate 400 by printing.

A connector terminal on an FPC side is compression-bonded to a pad group of the first electrode layer (first sensor coil group 100), and a controller is connected to the pad group via an FPC.

In addition, as in FIG. 6A, a magnetic shield plate may be provided to the lower side of the first electrode layer (first sensor coil group 100).

### Second Stack Configuration of Position Detecting Device 2

FIG. 6B illustrates a stack configuration including a flexible display.

As in FIG. 6A, the display layer 301 has what is called an on-cell touch sensor (capacitive sensor), and a layer on the upper side of the display layer 301 is provided with the touch sensor and with the second electrode layer (second sensor coil group 200). That is, the second stack configuration of the position detecting device 2 illustrated in FIG. 6B is a configuration in which the first electrode layer (first sensor coil group 100) and the second electrode layer (second sensor coil group 200) are provided in different layers separated from each other.

The second electrode layer (second sensor coil group 200) is formed on a side of a mounted substrate. The second electrode layer (second sensor coil group 200) is formed by arranging the plurality of second electrodes by using transparent electrodes on a side closer to the pen than the display layer 301.

The first electrode layer (first sensor coil group 100) is formed on a side of the upper surfaces of mounted support plates 400-1 and 400-2 with respect to the pen. Here, the lower surface of a display 300G is provided with the support plate 400, separated into the first support plate 400-1 and the second support plate 400-2.

While the first support plate 400-1 and the second support plate 400-2 are separated from each other, a configuration may be adopted in which a structure or another member for facilitating bending while having durability to folding, described as “grooves” in US2023/0071229A1 mentioned above, is provided between the support plates.

In the configuration of FIG. 6B, the first electrode layer (first sensor coil group 100-1) is directly provided on the upper surface of the first support plate 400-1, and the first electrode layer (first sensor coil group 100-2) is directly provided on the upper surface of the second support plate 400-2. Preferably, the support plate 400 is a rigid substrate having rigidity such as a glass epoxy substrate (FR4 or the like), and the first electrode layer (first sensor coil group 100-1) and the first electrode layer (first sensor coil group 100-2) are provided by mounting a conductive material such as copper or silver onto a surface (surface on the upper side in FIG. 6B) of the support plate 400 by printing.

In addition, a pad group or a part of first sensor coil wiring connected via a via to the first electrode layer (the first sensor coil group 100-1 and the first sensor coil group 100-2) formed on the upper surface sides of the first support plate 400-1 and the second support plate 400-2 is mounted by printing onto a lower surface of the first support plate 400-1 and the second support plate 400-2 and is compression-bonded to a connector terminal connected to a flexible board.

Incidentally, as illustrated in FIG. 6B, a magnetic shield plate may be provided to the lower sides of the first support plate 400-1 and the second support plate 400-2 on which the first electrode layer (first sensor coil group 100-1) or the first electrode layer (first sensor coil group 100-2) is mounted.

### Third Stack Configuration of Position Detecting Device 2

In a configuration of FIG. 6C, unlike FIG. 6B, the lower surfaces of the first support plate 400-1 and the second support plate 400-2, separated from each other, are directly provided with the first electrode layer (first sensor coil group 100-1) or the first electrode layer (first sensor coil group 100-2). That is, the third stack configuration of the position detecting device 2 illustrated in FIG. 6C is a configuration in which the first electrode layer (first sensor coil group 100) and the second electrode layer (second sensor coil group 200) are provided in different layers separated from each other.

The second electrode layer (second sensor coil group 200) is formed on a side of the mounted substrate. The second electrode layer (second sensor coil group 200) is formed by arranging the plurality of second electrodes by using transparent electrodes on a side closer to the pen than the display layer 301.

A connector terminal on an FPC side is compression-bonded to the first electrode layer (first sensor coil group 100-1) and the first electrode layer (first sensor coil group 100-2), and a controller is connected to the first electrode layer (first sensor coil group 100-1) and the first electrode layer (first sensor coil group 100-2) via an FPC.

Incidentally, as in FIG. 6C, a magnetic shield plate may be provided to the lower sides of the first electrode layer (first sensor coil group 100-1) and the first electrode layer (first sensor coil group 100-2).

### Fourth Stack Configuration of Position Detecting Device 2

FIG. 6D illustrates a stack configuration formed by providing the first electrode layer (first sensor coil group 100) to the touch sensor on the upper side of the display layer 301 and providing the second electrode layer (second sensor coil group 200) to the lower surface of the support plate 400 by printing. That is, the fourth stack configuration of the position detecting device 2 illustrated in FIG. 6D is a configuration in which the first electrode layer (first sensor coil group 100) and the second electrode layer (second sensor coil group 200) are provided in different layers separated from each other.

The first electrode layer (first sensor coil group 100) is provided with a plurality of first electrodes by using transparent electrodes on a side closer to the pen than the display layer 301. A connector terminal on an FPC side is compression-bonded to the second electrode layer (second sensor coil group 200), and a controller is connected to the second electrode layer (second sensor coil group 200) via an FPC.

Incidentally, as illustrated in FIG. 6D, a magnetic shield plate may be provided to the lower side of the second electrode layer (second sensor coil group 200).

### Fifth Stack Configuration of Position Detecting Device 2

FIG. 6E illustrates a stack configuration formed by providing the first electrode layer (first sensor coil group 100) to the touch sensor on the upper side of the display layer 301, providing the second electrode layer (second sensor coil group 200) to the upper surface of the support plate 400 by printing, providing a pad group 140 or a part of second sensor coil wiring to be described later to the lower surface of the support plate 400, and drawing out an FPC from the lower surface.

That is, the fifth stack configuration of the position detecting device 2 illustrated in FIG. 6E is a configuration in which the first electrode layer (first sensor coil group 100) and the second electrode layer (second sensor coil group 200) are provided in different layers separated from each other. The first electrode layer (first sensor coil group 100) is provided with the plurality of first electrodes by using transparent electrodes on a side closer to the pen than the display layer 301.

In addition, a pad group or a part of second sensor coil wiring connected via a via to the second electrode layer (second sensor coil group 200) formed on the upper surface side of the support plate 400 is mounted by printing onto the lower surface of the support plate 400, and is compression-bonded to a connector terminal connected to a flexible board.

Incidentally, as illustrated in FIG. 6E, a magnetic shield plate may be provided on the lower side of the second electrode layer (second sensor coil group 200).

### Sixth Stack Configuration of Position Detecting Device 2

FIG. 6F illustrates a stack configuration in a case where the second electrode layer (second sensor coil group 200) or the first electrode layer (first sensor coil group 100) is integrated with the TFT back panel layer 302 under the display layer 301, and the first electrode layer (first sensor coil group 100) or the second electrode layer (second sensor coil group 200) is directly mounted onto the support plate 400 by printing. That is, as illustrated in FIG. 6F, the sixth stack configuration of the position detecting device 2 is a configuration in which the first electrode layer (first sensor coil group 100) and the second electrode layer (second sensor coil group 200) are provided in different layers separated from each other.

In addition, a connector terminal on an FPC side is compression-bonded to a pad group of the first electrode layer (first sensor coil group 100) formed on the lower surface of the support plate 400 with respect to the pen, and a controller is connected to the pad group via an FPC.

Incidentally, as illustrated in FIG. 6F, a magnetic shield plate may be provided to the lower side of the first electrode layer (first sensor coil group 100) or the second electrode layer (second sensor coil group 200).

### Configuration of First Electrode Layer (First Sensor Coil Group 100)

FIG. 7A and FIG. 7B are diagrams illustrating examples of a configuration of the first electrode layer (first sensor coil group 100).

The configurations of the first electrode layer (first sensor coil group 100) illustrated in FIG. 7A and FIG. 7B are effective particularly in a case of using a flexible display capable of being folded as in the configuration examples of FIGS. 6A to 6F.

With the configuration illustrated in FIG. 7A, in FIG. 6A or FIG. 6F, for example, the first electrode layer (first sensor coil group 100) is formed on the lower surface side or the upper surface side of the support plate 400 with respect to the pen.

Specifically, as illustrated in FIG. 6A or FIG. 6F, the first electrode layer (first sensor coil group 100) is coupled to a surface of the support plate 400 by printing.

With the configuration illustrated in FIG. 7B, in FIG. 6B or FIG. 6C, for example, the support plate 400 is separated, and the first electrode layer is formed on the upper surface sides or the lower surface sides of the separated support plates 400-1 and 400-2 with respect to the pen. Specifically, in the configuration of FIG. 7B, the first electrode layer (first sensor coil group 100) includes a first electrode layer (first sensor coil group 100-1) coupled to the support plate 400-1 in FIG. 6B or FIG. 6C by printing and a second first electrode layer (first sensor coil group 100-2) mounted onto the support plate 400-2 by printing.

Incidentally, a folding portion 400-3 as a member or a structure having flexibility may be provided between the support plate 400-1 and the support plate 400-2, and the part may be provided with a folding waist portion connecting conductor 131 formed by a material or a structure that is less likely to cause a break in response to a bending operation than a connecting conductor 130 as another first connector.

The first electrode layer (first sensor coil group 100) includes a first electrode 120, . . . , a first electrode 135 respectively constituting first sensor coils T0, T1, . . . , T15 and the connecting conductor 130 that connects the first electrodes 120 to 135 to one another. The first electrode layer (first sensor coil group 100) is thereby formed in the form of a comb shape (saw shape).

As illustrated in FIG. 7A, the first electrodes 120 to 135 are connected to a pad group 140. As illustrated in FIG. 7B, the first electrodes 120 to 127 are connected to a first pad group 140-1, and the first electrodes 128 to 135 are connected to a second pad group 140-2.

A connector terminal of an FPC not illustrated is compression-bonded to the pad group 140 of the first electrode layer (first sensor coil group 100), and controller pins corresponding to respective terminals of the pad group 140 are connected to the pad group 140 via the FPC. The controller thus drives the pad group 140 as the first sensor coils.

### Actions and Effects

As described above, the position detecting device 2 according to the present embodiment includes the first electrode layer (first sensor coil group 100) provided with the first electrodes that generate the alternating magnetic field, and the second electrode layer (second sensor coil group 200) provided with the plurality of second electrodes that detect the pen alternating magnetic field generated by the pen that has stored energy by the alternating magnetic field, the second electrode layer (second sensor coil group 200) being formed on a side of the substrate.

That is, the second electrode layer (second sensor coil group 200) is formed as one layer.

Therefore, this contributes to thinning the stack structure and improving designability.

The first stack configuration of the position detecting device 2 according to the present embodiment is a stack configuration including a flexible display capable of being folded. The display layer 301 has what is called an on-cell touch sensor (capacitive sensor), and a layer on the upper side of the display layer 301 is provided with the touch sensor, and is provided with the second electrode layer (second sensor coil group 200).

That is, the first stack configuration of the position detecting device 2 is a configuration in which the first electrode layer (first sensor coil group 100) and the second electrode layer (second sensor coil group 200) are provided in different layers separated from each other.

In addition, the second electrode layer (second sensor coil group 200) is formed on a surface side of the mounted substrate, and the plurality of second electrodes are arranged by using transparent electrodes on a side closer to the pen than the display layer 301. Further, the first electrode layer (first sensor coil group 100) is formed on the lower surface of the mounted support plate 400 with respect to the pen. It is therefore possible to thin the stack structure and improve designability while maintaining the performance of the position detecting device without impairing the visibility of the display 300G.

In addition, the first electrode layer (first sensor coil group 100) has a structure such that the first electrode layer (first sensor coil group 100) is formed on the lower surface of the mounted support plate 400 with respect to the pen, a connector terminal on an FPC side is compression-bonded to the first electrode layer (first sensor coil group 100), and a controller is connected to the first electrode layer (first sensor coil group 100) via an FPC.

In other words, the upper surface of the support plate 400 with respect to the pen remains flat, and therefore has a structure that does not affect flatness and inclination of the display 300G even when the display 300G is bonded to an upper portion of the support plate 400 by an adhesive or the like.

The second stack configuration of the position detecting device 2 according to the present embodiment is a stack configuration including a flexible display capable of being folded. The display layer 301 has what is called an on-cell touch sensor (capacitive sensor), and a layer on the upper side of the display front panel layer 301 is provided with the touch sensor and is provided with the second electrode layer (second sensor coil group 200).

On the other hand, the upper surfaces of the first support plate 400-1 and the second support plate 400-2, separated from each other, are directly provided with the first electrode layer (first sensor coil group 100-1) or the first electrode layer (first sensor coil group 100-2). That is, the second stack configuration of the position detecting device 2 is a configuration in which the first electrode layer (first sensor coil group 100) and the second electrode layer (second sensor coil group 200) are provided in different layers separated from each other.

In addition, the second electrode layer (second sensor coil group 200) is formed on a side of the mounted substrate, and the second electrode layer (second sensor coil group 200) is provided with the plurality of second electrodes by using transparent electrodes on a side closer to the pen than the display layer 301. Further, the first electrode layer (first sensor coil group 100) is formed the upper surfaces of the mounted support plates 400-1 and 400-2 with respect to the pen.

In addition, a pad group 140 or a part of first sensor coil wiring connected via a via to the first electrode layer (the first sensor coil group 100-1 and the first sensor coil group 100-2) formed on the upper surface sides of the first support plate 400-1 and the second support plate 400-2 is mounted by printing onto a lower surface of the first support plate 400-1 and the second support plate 400-2, and is compression-bonded to a connector terminal connected to a flexible board. It is therefore possible to thin the stack structure and improve designability while maintaining the performance of the position detecting device without impairing the visibility of the display 300G.

In addition, the first electrode layer (first sensor coil group 100) is formed on the upper surfaces of the mounted first support plate 400-1 and the mounted second support plate 400-2 with respect to the pen. A pad group, or a part of first sensor coil wiring connected via a via to the first electrode layer (the first sensor coil group 100-1 and the first sensor coil group 100-2) formed on the upper surface sides of the first support plate 400-1 and the second support plate 400-2, is mounted by printing onto a lower surface of the first support plate 400-1 and the second support plate 400-2, and is compression-bonded to a connector terminal connected to a flexible board.

Therefore, the upper surfaces of the first support plate 400-1 and the second support plate 400-2 have a structure that maintains flatness as much as possible, and thus have a structure that does not readily affect flatness and inclination of the display 300G even when the display 300G is bonded to upper portions of the first support plate 400-1 and the second support plate 400-2 by an adhesive or the like.

The third stack configuration of the position detecting device 2 according to the present embodiment is a stack configuration including a flexible display capable of being folded. In the stack configuration, including the flexible display capable of being folded, the display layer 301 has what is called an on-cell touch sensor (capacitive sensor), and a layer on the upper side of the display layer 301 is provided with the touch sensor, and is provided with the second electrode layer (second sensor coil group 200).

On the other hand, the lower surfaces of the first support plate 400-1 and the second support plate 400-2, separated from each other, are directly provided with the first electrode layer (first sensor coil group 100-1) or the first electrode layer (first sensor coil group 100-2). That is, the third stack configuration of the position detecting device 2 is a configuration in which the first electrode layer (first sensor coil group 100) and the second electrode layer (second sensor coil group 200) are provided in different layers separated from each other.

In addition, the second electrode layer (second sensor coil group 200) is formed on a side of the mounted substrate, and the second electrode layer (second sensor coil group 200) is provided with the plurality of second electrodes by using transparent electrodes on a side closer to the pen than the display 300J.

Further, a connector terminal on an FPC side is compression-bonded to the first electrode layer (first sensor coil group 100-1) and the first electrode layer (first sensor coil group 100-2), and a controller is connected to the first electrode layer (first sensor coil group 100-1) and the first electrode layer (first sensor coil group 100-2) via an FPC. It is therefore possible to thin the stack structure and improve designability while maintaining the performance of the position detecting device without impairing the visibility of the display 300J.

In addition, the first electrode layer (the first sensor coil group 100-1 and the first sensor coil group 100-2) has a structure such that the first electrode layer (the first sensor coil group 100-1 and the first sensor coil group 100-2) is formed on the lower surfaces of the mounted first support plate 400-1 and the mounted second support plate 400-2 with respect to the pen, a connector terminal on an FPC side is compression-bonded to the first electrode layer (the first sensor coil group 100-1 and the first sensor coil group 100-2), and a controller is connected to the first electrode layer (the first sensor coil group 100-1 and the first sensor coil group 100-2) via an FPC.

In other words, the upper surfaces of the first support plate 400-1 and the second support plate 400-2 with respect to the pen remain flat, and therefore have a structure that does not affect flatness and inclination of the display 300J even when the display 300J is bonded to upper portions of the first support plate 400-1 and the second support plate 400-2 by an adhesive or the like.

The fourth stack configuration of the position detecting device 2 according to the present embodiment is a stack configuration including a flexible display capable of being folded, and represents a stack configuration formed by providing the first electrode layer (first sensor coil group 100) to the touch sensor on the upper side of the display layer 301, and providing the second electrode layer (second sensor coil group 200) to a lower surface of the support plate 400 by printing. That is, the fourth stack configuration of the position detecting device 2 is a configuration in which the first electrode layer (first sensor coil group 100) and the second electrode layer (second sensor coil group 200) are provided in different layers separated from each other.

In addition, the first electrode layer (first sensor coil group 100) is provided with the plurality of first electrodes by using transparent electrodes on a side closer to the pen than the display layer 301. It is therefore possible to thin the stack structure and improve designability while maintaining the performance of the position detecting device without impairing the visibility of the display 300J.

In addition, the second electrode layer (second sensor coil group 200) has a structure such that the second electrode layer (second sensor coil group 200) is formed on the lower surface of the mounted support plate 400 with respect to the pen, a connector terminal on an FPC side is compression-bonded to the second electrode layer (second sensor coil group 200), and a controller is connected to the second electrode layer (second sensor coil group 200) via an FPC.

In other words, the upper surface of the support plate 400 with respect to the pen remains flat, and therefore has a structure that does not affect flatness and inclination of the display 300J even when the display 300J is bonded to an upper portion of the support plate 400 by an adhesive or the like.

The fifth stack configuration of the position detecting device 2 according to the present embodiment is a stack configuration including a flexible display capable of being folded, and represents a configuration obtained by providing the first electrode layer (first sensor coil group 100) to the touch sensor on the upper side of the display layer 301, providing the second electrode layer (second sensor coil group 200) to the upper surface of the support plate 400 by printing, providing a pad group 140 or a part of second sensor coil wiring to be described later to the lower surface of the support plate 400, and drawing out an FPC from the lower surface.

That is, the fifth stack configuration of the position detecting device 2 is a configuration in which the first electrode layer (first sensor coil group 100) and the second electrode layer (second sensor coil group 200) are provided in different layers separated from each other. In addition, the first electrode layer (first sensor coil group 100) is provided with the plurality of first electrodes by using transparent electrodes on a side closer to the pen than the display layer 301. It is therefore possible to thin the stack structure and improve designability while maintaining the performance of the position detecting device without impairing the visibility of the display 300J.

In addition, the second electrode layer (second sensor coil group 200) is formed on the upper surface of the mounted support plate 400 with respect to the pen, and a pad group 140, or a part of second sensor coil wiring connected via a via to the second electrode layer (second sensor coil group 200) formed on the upper surface side of the support plate 400, is mounted by printing onto the lower surface of the support plate 400, and is compression-bonded to a connector terminal connected to a flexible board.

Therefore, the upper surface of the support plate 400 has a structure that maintains flatness as much as possible, and thus has a structure that does not readily affect flatness and inclination of the display 300J even when the display 300J is bonded to an upper portion of the support plate 400 by an adhesive or the like.

The sixth stack configuration of the position detecting device 2 according to the present embodiment is a stack configuration including a flexible display capable of being folded, and represents a stack configuration in a case where the second electrode layer (second sensor coil group 200) or the first electrode layer (first sensor coil group 100) is integrated with the TFT back panel layer 302 of a display 300L, and the first electrode layer (first sensor coil group 100) or the second electrode layer (second sensor coil group 200) is directly mounted onto the support plate 400 by printing. That is, the seventh stack configuration of the position detecting device 2 is a configuration in which the first electrode layer (first sensor coil group 100) and the second electrode layer (second sensor coil group 200) are provided in different layers separated from each other. It is therefore possible to thin the stack structure and improve designability while maintaining the performance of the position detecting device without impairing the visibility of the display 300L.

In addition, the first electrode layer (first sensor coil group 100) has a structure such that the first electrode layer (first sensor coil group 100) is formed on the lower surface of the mounted support plate 400 with respect to the pen, a connector terminal on an FPC side is compression-bonded to the first electrode layer (first sensor coil group 100), and a controller is connected to the first electrode layer (first sensor coil group 100) via an FPC.

In other words, the upper surface of the support plate 400 with respect to the pen remains flat, and therefore has a structure that does not affect flatness and inclination of the display 300L even when the display 300L is bonded to an upper portion of the support plate 400 by an adhesive or the like.

The first electrode layer (first sensor coil group 100) of the position detecting device 2 according to the present embodiment is formed on the lower surface side or the upper surface side of the support plate 400 with respect to the pen. Specifically, as illustrated in FIG. 6A and FIGS. 6D to 6F, the first electrode layer (first sensor coil group 100) is mounted onto the support plate 400 by printing.

In addition, the first electrode layer (first sensor coil group 100) of the position detecting device 2 according to the present embodiment includes the first electrode 120, . . . , the first electrode 135 respectively constituting the first sensor coils T0, T1, . . . , T15 and the connecting conductor 130 as the second connector that connects the first electrodes 120 to 135 to one another. The first electrode layer (first sensor coil group 100) is thereby formed in the form of a comb shape (saw shape). That is, in the first electrode layer (first sensor coil group 100) of the position detecting device 2 according to the present embodiment, the switch 11 is controlled to thereby, for example, bundle the first electrode 125 and the first electrode 126 and connect the first electrode 125 and the first electrode 126 to the first terminal of the first circuit 10, while bundling the first electrode 128 and the first electrode 129 and connecting the first electrode 128 and the first electrode 129 to the firs _inv terminal of the first circuit 10.

In addition, the first circuit 10 performs control such that current change amounts of the first terminal and the first_inv terminal are in opposite phases from each other. A strong sending-out magnetic field can be thereby formed between the bundle of the first electrode 125 and the first electrode 126 and the bundle of the first electrode 128 and the first electrode 129 (in the vicinity of the first electrode 127) as compared with a case where no bundles are made or as compared with a case where the first_inv terminal is set at a fixed potential. In other words, by bundling pluralities of first electrodes, it is possible to form a sending-out magnetic field of a desired strength even when the first electrode layer (first sensor coil group 100) is formed by the first electrodes that are small in line width and thus high in impedance.

In the position detecting device 2 according to the present embodiment, the support plate 400 is separated, and the first electrode layer (first sensor coil group 100) is formed on the upper surface sides or the lower surface sides of the separated support plates 400-1 and 400-2 with respect to the pen. Specifically, the first electrode layer (first sensor coil group 100) has the configuration of FIG. 7B. The first electrode layer (first sensor coil group 100) includes a first electrode layer (first sensor coil group 100-1) mounted onto the support plate 400-1 in FIG. 6B and FIG. 6C by printing and a second first electrode layer (first sensor coil group 100-2) mounted onto the support plate 400-2 by printing.

In addition, the first electrode layer (first sensor coil group 100) of the position detecting device 2 according to the present embodiment includes the first electrode 120, . . . , the first electrode 135 respectively constituting the first sensor coils T0, T1, . . . , T15 and the connecting conductor 130 as the second connector that connects the first electrodes 120 to 135 to one another. The first electrode layer (first sensor coil group 100) is thereby formed in the form of a comb shape (saw shape).

That is, in the first electrode layer (first sensor coil group 100) of the position detecting device 2 according to the present embodiment, the switch 11 is controlled to thereby, for example, bundle the first electrode 125 and the first electrode 126 and connect the first electrode 125 and the first electrode 126 to the first terminal of the first circuit 10, while bundling the first electrode 128 and the first electrode 129 and connecting the first electrode 128 and the first electrode 129 to the first_inv terminal of the first circuit 10.

In addition, the first circuit 10 performs control such that current change amounts of the first terminal and the first_inv terminal are in opposite phases from each other. A strong sending-out magnetic field can be thereby formed between the bundle of the first electrode 125 and the first electrode 126 and the bundle of the first electrode 128 and the first electrode 129 (in the vicinity of the first electrode 127) as compared with a case where no bundles are made or as compared with a case where the first_inv terminal is set at a fixed potential.

In other words, by bundling pluralities of first electrodes, it is possible to form a sending-out magnetic field of a desired strength even when the first electrode layer (first sensor coil group 100) is formed by the first electrodes that are small in line width and thus high in impedance.

In a position detecting device 3 according to the present embodiment, the second electrode layer (second sensor coil group 200) and the first electrode layer (first sensor coil group 100) are separated from each other, and the comb-shaped first electrode layer (first sensor coil group 100) or the second electrode layer (second sensor coil group 200) that does not necessitate a plurality of layers and which can be mounted on a single surface by printing or the like is integrally formed on one of the support plates 400, 400-1, and 400-2 for protecting the flexible display by printing on the support plates 400, 400-1, and 400-2 or the like.

Therefore, a reduction in thickness is achieved, and a reduction in manufacturing processes can be achieved, as compared with a case of making a configuration in which the support plates 400, 400-1, and 400-2 and an EMR (electromagnetic resonance) sensor coil group provided with the first electrode layer (first sensor coil group 100) and the second electrode layer (second sensor coil group 200) as a plurality of layers are formed in different substrates, and these substrates are laminated.

### Third Embodiment

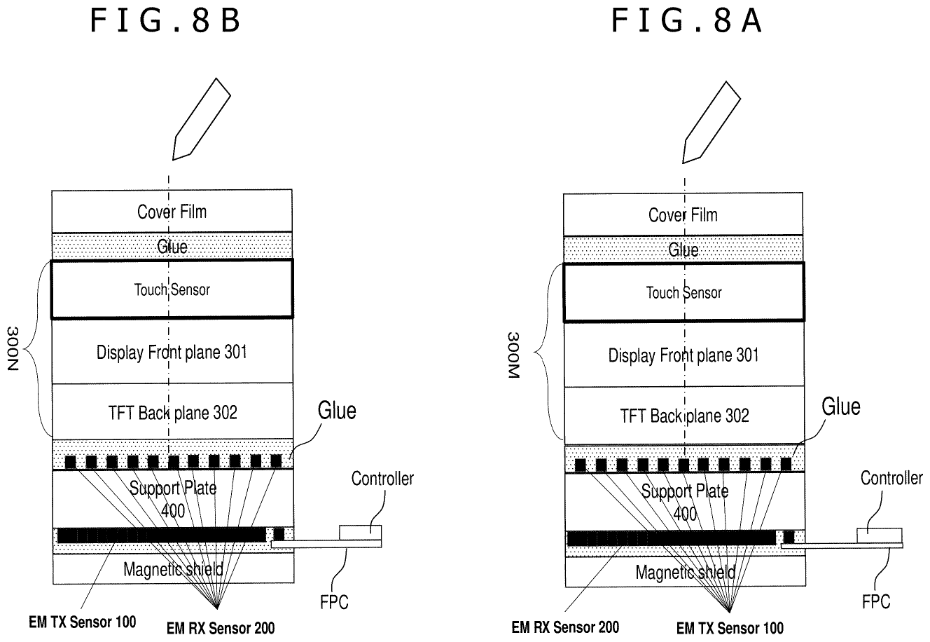

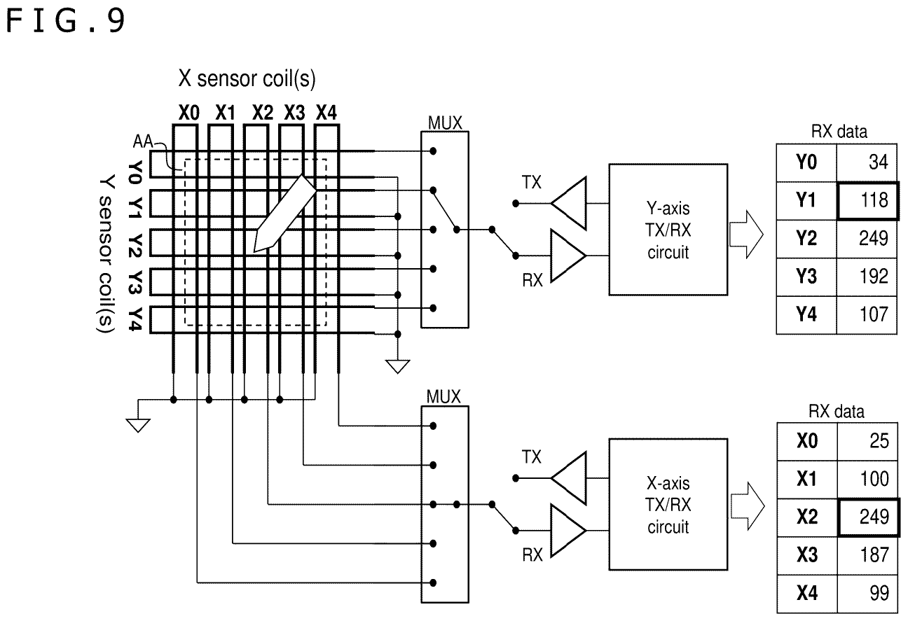

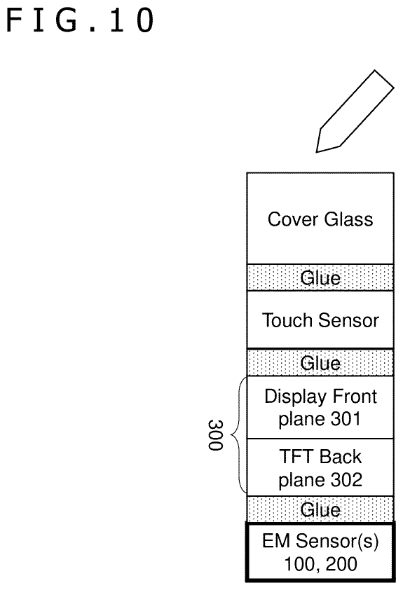

The position detecting device 3 according to the present embodiment will be described with reference to FIG. 8A and FIG. 8B.

### Configuration of Position Detecting Device 3

FIG. 8A illustrates a stack configuration in which the first electrode layer (first sensor coil group 100) is formed on the upper surface of the support plate 400, and the second electrode layer (second sensor coil group 200) is formed on the lower surface of the support plate 400, as opposed to the position detecting device 2 according to the second embodiment, in which the first electrode layer (first sensor coil group 100) and the second electrode layer (second sensor coil group 200) are provided in different layers separated from each other. In addition, a connector terminal on an FPC side is compression-bonded to the second electrode layer (second sensor coil group 200), and a controller is connected to the second electrode layer (second sensor coil group 200) via an FPC.

FIG. 8B illustrates a stack configuration in which the first electrode layer (first sensor coil group 100) is formed on the lower surface of the support plate 400, and the second electrode layer (second sensor coil group 200) is formed on the upper surface of the support plate 400 as opposed to the position detecting device 2 according to the second embodiment, in which the first electrode layer (first sensor coil group 100) and the second electrode layer (second sensor coil group 200) are provided in different layers separated from each other.

In addition, a connector terminal on an FPC side is compression-bonded to the first electrode layer (first sensor coil group 100), and a controller is connected to the first electrode layer (first sensor coil group 100) via an FPC.

### Actions and Effects

As described above, the position detecting device 3 according to the present embodiment has a stack configuration in which the first electrode layer (first sensor coil group 100) is formed on the upper surface of the support plate 400, and the second electrode layer (second sensor coil group 200) is formed on the lower surface of the support plate 400. In addition, a connector terminal on an FPC side is compression-bonded to the second electrode layer (second sensor coil group 200), and a controller is connected to the second electrode layer (second sensor coil group 200) via an FPC.

That is, also in the stack configuration as described above, one of the first electrode layer (first sensor coil group 100) formed as one layer and the second electrode layer (second sensor coil group 200) formed as one layer is disposed on only one surface of the support plate 400, and consequently a corresponding reduction in thickness can be achieved as compared with a case where a plurality of layers are provided for each sensor coil group.

In addition, the first electrode layer (first sensor coil group 100) is formed on the upper surface of the mounted support plate 400 with respect to the pen, and a pad group 140 or a part of first sensor coil wiring connected via a via to the first electrode layer (first sensor coil group 100) formed on the upper surface side of the support plate 400 is mounted onto the lower surface of the support plate 400 by printing, and is compression-bonded to a connector terminal connected to a flexible board. Therefore, the upper surface of the support plate 400 has a structure that maintains flatness as much as possible, and thus has a structure that does not readily affect flatness and inclination of a display 300M even when the display 300M is bonded to an upper portion of the support plate 400 by an adhesive or the like.

The position detecting device 3 according to the present embodiment has a stack configuration in which the first electrode layer (first sensor coil group 100) is formed on the lower surface of the support plate 400, and the second electrode layer (second sensor coil group 200) is formed on the upper surface of the support plate 400. In addition, a connector terminal on an FPC side is compression-bonded to the first electrode layer (first sensor coil group 100), and a controller is connected to the first electrode layer (first sensor coil group 100) via an FPC.

That is, also in the stack configuration as described above, one of the first electrode layer (first sensor coil group 100) formed as one layer and the second electrode layer (second sensor coil group 200) formed as one layer is disposed on only one surface of the support plate 400, and consequently a corresponding reduction in thickness can be achieved as compared with a case where a plurality of layers are provided for each sensor coil group.

In addition, the second electrode layer (second sensor coil group 200) is formed on the upper surface of the mounted support plate 400 with respect to the pen, and a pad group 140 or a part of second sensor coil wiring connected via a via to the second electrode layer (second sensor coil group 200) formed on the upper surface side of the support plate 400 is mounted onto the lower surface of the support plate 400 by printing, and is compression-bonded to a connector terminal connected to a flexible board.

Therefore, the upper surface of the support plate 400 has a structure that maintains flatness as much as possible, and thus has a structure that does not readily affect flatness and inclination of a display 300N even when the display 300N is bonded to an upper portion of the support plate 400 by an adhesive or the like.

### Fourth Embodiment

A display device 4 according to the present embodiment will be described with reference to FIGS. 6A to 6F.

### Configuration of Display Device 4

The display device 4 according to the present embodiment is a display device 4 for use in the position detecting device 2 for detecting the position of a pen by using electromagnetic induction action, the display device 4 including, for example, a display layer 301 and a TFT back panel 302 provided to the lower surface of the display layer 301. The TFT back panel 302 is mounted with TFTs that drive display pixel electrodes of the display layer 301 and a touch panel TS provided on an upper portion of the display layer 301. At least either a first electrode layer (first sensor coil group 100) or a second electrode layer (second sensor coil group 200) is provided in the TFT back panel 302 or the touch panel TS. The first electrode layer (first sensor coil group 100) is provided with a first electrode that generates an alternating magnetic field and the second electrode layer (second sensor coil group 200) is provided with a plurality of second electrodes that detect a pen alternating magnetic field generated by the pen that has stored energy through the alternating magnetic field.

As illustrated in FIGS. 6A to 6F, for example, the display device 4 according to the present embodiment includes a support plate provided on the lower side of the display layer 301 with respect to the pen, with either the first electrode layer (first sensor coil group 100) or the second electrode layer (second sensor coil group 200) being formed on the support plate.

Incidentally, stack configurations of the display device 4 and constituent elements identified by the same reference numerals are similar to those of the second and third embodiments, and therefore a detailed description thereof will be omitted.

For example, in FIG. 6A, it is illustrated that the first electrode layer (first sensor coil group 100) is formed on the lower surface side of the support plate 400 with respect to the pen. A connector terminal on an FPC side is compression-bonded to a pad group 140 of the first electrode layer (first sensor coil group 100) formed on the lower surface of the support plate 400 with respect to the pen, and a controller is connected to the pad group 140 via an FPC.

In addition, it is illustrated that the second electrode layer (second sensor coil group 200) is provided in a state of being integrated with the touch panel TS.

For example, in FIG. 6B, it is illustrated that the support plate 400 is separated into two support plates 400-1 and 400-2, that the first electrode layer (first sensor coil group 100) is formed on the upper surface sides of the separated support plates 400-1 and 400-2 with respect to the pen, and that a pad group or a part of first sensor coil wiring is formed on the lower surface side of the separated support plates 400-1 and 400-2.

In addition, it is illustrated that the second electrode layer (second sensor coil group 200) is integrated with the touch panel TS.

In addition, it is illustrated that the pad group is connected, on the lower surface side of the separated support plates 400-1 and 400-2, to the first electrode layer (first sensor coil group 100) formed on the upper surface sides of the separated support plates 400-1 and 400-2 via a via, and is compression-bonded to a connector terminal connected to a flexible board.

For example, in FIG. 6C, it is illustrated that the support plate 400 is separated into two support plates 400-1 and 400-2, that the first electrode layer (first sensor coil group 100) is formed on the lower surface sides of the separated support plates 400-1 and 400-2 with respect to the pen, that a connector terminal on an FPC side is compression-bonded to the pad group 140 of the first electrode layer (first sensor coil group 100), and that a controller is connected to the pad group 140 of the first electrode layer (first sensor coil group 100) via an FPC.

In addition, it is illustrated that the second electrode layer (second sensor coil group 200) is integrated with the touch panel TS. For example, in FIG. 6D, it is illustrated that the second electrode layer (second sensor coil group 200) is formed on the lower surface side of the support plate 400 with respect to the pen.

It is illustrated that the first electrode layer (first sensor coil group 100) is integrated with the touch panel TS. In addition, it is illustrated that a connector terminal on an FPC side is compression-bonded to the second electrode layer (second sensor coil group 200) and that a controller is connected to the second electrode layer (second sensor coil group 200) via an FPC. For example, in FIG. 6E, it is illustrated that the second electrode layer (second sensor coil group 200) is formed on the upper surface side of the support plate 400 with respect to the pen, and that a pad group 140 or a part of second sensor coil wiring is formed on the lower surface side of the support plate 400.

In addition, it is illustrated that the first electrode layer (first sensor coil group 100) is integrated with the touch panel TS.

In addition, it is illustrated that the pad group 140 is connected, on the lower surface side of the support plate 400, to the second electrode layer (second sensor coil group 200) formed on the upper surface side of the support plate 400 via a via, and is compression-bonded to a connector terminal connected to a flexible board. For example, in FIG. 6F, it is illustrated that the first electrode layer (first sensor coil group 100) is formed on the lower surface side of the support plate 400 with respect to the pen.

In addition, it is illustrated that the second electrode layer (second sensor coil group 200) is provided in a state of being integrated with the TFT back panel 302.

### Actions and Effects

The display device 4 according to the present embodiment is a display device 4 for use in the position detecting device 2 for detecting the position of the pen by using electromagnetic induction action. The display device 4 includes, for example, a display layer 301, a TFT back panel 302 provided to the lower surface of the display layer 301, the TFT back panel 302 being mounted with TFTs that drive display pixel electrodes of the display layer 301, and a touch panel TS provided on an upper portion of a display 30. At least either a first electrode layer (first sensor coil group 100) or a second electrode layer (second sensor coil group 200) is provided in the TFT back panel 302 or the touch panel TS, and the first electrode layer (first sensor coil group 100) is provided with a first electrode that generates an alternating magnetic field. The second electrode layer (second sensor coil group 200) is provided with a plurality of second electrodes that detect a pen alternating magnetic field generated by the pen that has stored energy through the alternating magnetic field.

That is, the first electrode layer (first sensor coil group 100) or the second electrode layer (second sensor coil group 200) is formed on at least one surface of the support plate 400 provided on a lower side more distant from the pen than the display 30. It is therefore possible to thin the stack structure and improve designability while maintaining the performance of the position detecting device without impairing the visibility of the displays 300G, 300J, and 300L.

It is illustrated that the display device 4 according to the present embodiment has the first electrode layer (first sensor coil group 100) formed on the lower surface side of the support plate 400 with respect to the pen. Further, a connector terminal on an FPC side is compression-bonded to the pad group 140 of the first electrode layer (first sensor coil group 100) formed on the lower surface of the support plate 400 with respect to the pen, and a controller is connected to the pad group 140 of the first electrode layer (first sensor coil group 100) via an FPC.

In addition, the second electrode layer (second sensor coil group 200) is integrated with the touch panel TS. That is, a large current flows through the first electrode layer (first sensor coil group 100) because the first electrode layer (first sensor coil group 100) generates the alternating magnetic field. Thus, the line width of a wiring pattern forming the first electrodes is large in order to decrease impedance. When the first electrode layer (first sensor coil group 100) is formed in a layer higher than the display layer 301, the visibility of the display 300G may be impaired.

In the display device 4 according to the present embodiment, the first electrode layer (first sensor coil group 100) is formed on the lower surface side of the support plate 400 with respect to the pen. It is therefore possible to thin the stack structure and improve designability while maintaining the performance of the position detecting device without impairing the visibility of the display device 4.

In addition, because the second electrode layer (second sensor coil group 200) is integrated with the touch panel TS, it is possible to thin the stack structure and improve designability while maintaining the performance of the position detecting device. In addition, because the first electrode layer (first sensor coil group 100) is formed on the support plate 400 indispensable to the display device 4 of a folding type, the above-described effects can be produced also in the display device 4 of the folding type.

Further, the first electrode layer (first sensor coil group 100) has a structure such that the first electrode layer (first sensor coil group 100) is formed on the lower surface of the mounted support plate 400 with respect to the pen, a connector terminal on an FPC side is compression-bonded to the first electrode layer (first sensor coil group 100), and a controller is connected to the first electrode layer (first sensor coil group 100) via an FPC. In other words, the upper surface of the support plate 400 with respect to the pen remains flat, and therefore has a structure that does not affect flatness and inclination of the display 300G even when the display 300G is bonded to an upper portion of the support plate 400 by an adhesive or the like.

In the display device 4 according to the present embodiment, the support plate 400 is separated, and the first electrode layer (first sensor coil group 100) is formed on upper surface sides of the separated support plates 400-1 and 400-2 with respect to the pen. That is, a large current flows through the first electrode layer (first sensor coil group 100) because the first electrode layer (first sensor coil group 100) generates the alternating magnetic field. Thus, the line width of a wiring pattern forming the first electrodes is large in order to decrease impedance. When the first electrode layer (first sensor coil group 100) is formed in a layer higher than the display 300G, the visibility of the display 300G may be impaired.

In the display device 4 according to the present embodiment, the first electrode layer (first sensor coil group 100) is formed on the lower surface sides of the support plates 400-1 and 400-2 with respect to the pen. It is therefore possible to thin the stack structure and improve designability while maintaining the performance of the position detecting device without impairing the visibility of the display 300G.

In addition, because the second electrode layer (second sensor coil group 200) is integrated with the touch panel TS, it is possible to thin the stack structure and improve designability while maintaining the performance of the position detecting device.

In addition, because the first electrode layer (first sensor coil group 100) is formed on the support plates 400-1 and 400-2 indispensable to the display device 4 of the folding type, the above-described effects can be produced also in the display device 4 of the folding type. In addition, a pad group 140, or a part of first sensor coil wiring connected via a via to the first electrode layer (the first sensor coil group 100-1 and the first sensor coil group 100-2) formed on the upper surface sides of the first support plate 400-1 and the second support plate 400-2, is mounted by printing onto a lower surface of the first support plate 400-1 and the second support plate 400-2, and is compression-bonded to a connector terminal connected to a flexible board.

Therefore, the upper surfaces of the first support plate 400-1 and the second support plate 400-2 have a structure that maintains flatness as much as possible, and thus have a structure that does not readily affect flatness and inclination of the display 300G even when the display 300G is bonded to upper portions of the first support plate 400-1 and the second support plate 400-2 by an adhesive or the like.

In the display device 4 according to the present embodiment, the support plate 400 is separated, and the first electrode layer (first sensor coil group 100) is formed on lower surface sides of the separated support plates 400-1 and 400-2 with respect to the pen. That is, a large current flows through the first electrode layer (first sensor coil group 100) because the first electrode layer (first sensor coil group 100) generates the alternating magnetic field. Thus, the line width of a wiring pattern forming the first electrodes is large in order to decrease impedance. When the first electrode layer (first sensor coil group 100) is formed in a layer higher than the display 300J, the visibility of the display 300J may be impaired.

In the display device 4 according to the present embodiment, the support plates 400-1 and 400-2 are separated from each other, and the first electrode layer (first sensor coil group 100) is formed on the lower surface sides of the separated support plates 400-1 and 400-2 with respect to the pen. It is therefore possible to thin the stack structure and improve designability while maintaining the performance of the position detecting device without impairing the visibility of the display 300J. In addition, because the second electrode layer (second sensor coil group 200) is integrated with the touch panel TS, it is possible to thin the stack structure and improve designability while maintaining the performance of the position detecting device. In addition, because the first electrode layer (first sensor coil group 100) is formed on the support plates 400-1 and 400-2 indispensable to the display device 4 of the folding type, the above-described effects can be produced also in the display device 4 of the folding type.

In addition, the first electrode layer (the first sensor coil group 100-1 and the first sensor coil group 100-2) has a structure such that the first electrode layer (the first sensor coil group 100-1 and the first sensor coil group 100-2) is formed on the lower surfaces of the mounted first support plate 400-1 and the mounted second support plate 400-2 with respect to the pen, a connector terminal on an FPC side is compression-bonded to the first electrode layer (the first sensor coil group 100-1 and the first sensor coil group 100-2), and a controller is connected to the first electrode layer (the first sensor coil group 100-1 and the first sensor coil group 100-2) via an FPC.

In other words, the upper surfaces of the first support plate 400-1 and the second support plate 400-2 with respect to the pen remain flat, and therefore have a structure that does not affect flatness and inclination of the display 300J even when the display 300J is bonded to upper portions of the first support plate 400-1 and the second support plate 400-2 by an adhesive or the like.

In the display device 4 according to the present embodiment, the second electrode layer (second sensor coil group 200) is formed on the lower surface side of the support plate 400 with respect to the pen, and the first electrode layer (first sensor coil group 100) is integrated with the touch panel TS and includes a plurality of transparent electrodes. It is therefore possible to thin the stack structure and improve designability while maintaining the performance of the position detecting device without impairing the visibility of the display 300J.

In addition, because the second electrode layer (second sensor coil group 200) is formed on the support plate 400 indispensable to the display device 4 of the folding type, the above-described effects can be produced also in the display device 4 of the folding type. In addition, the second electrode layer (second sensor coil group 200) has a structure such that the second electrode layer (second sensor coil group 200) is formed on the lower surface of the mounted support plate 400 with respect to the pen, a connector terminal on an FPC side is compression-bonded to the second electrode layer (second sensor coil group 200), and a controller is connected to the second electrode layer (second sensor coil group 200) via an FPC.

In other words, the upper surface of the support plate 400 with respect to the pen remains flat, and therefore has a structure that does not affect flatness and inclination of the display 300J even when the display 300J is bonded to an upper portion of the support plate 400 by an adhesive or the like.

In the display device 4 according to the present embodiment, the second electrode layer (second sensor coil group 200) is formed on the upper surface side of the support plate 400 with respect to the pen, a pad group 140 or a part of second sensor coil wiring is formed on the lower surface side of the support plate 400, and the first electrode layer (first sensor coil group 100) is integrated with the touch panel TS, and includes a plurality of transparent electrodes. It is therefore possible to thin the stack structure and improve designability while maintaining the performance of the position detecting device without impairing the visibility of the display 300J.

In addition, because the second electrode layer (second sensor coil group 200) is formed on the support plate 400 indispensable to the display device 4 of the folding type, the above-described effects can be produced also in the display device 4 of the folding type. In addition, the second electrode layer (second sensor coil group 200) is formed on the upper surface of the mounted support plate 400 with respect to the pen, and a pad group 140 or a part of second sensor coil wiring connected via a via to the second electrode layer (second sensor coil group 200) formed on the upper surface side of the support plate 400 is mounted by printing onto the lower surface of the support plate 400, and is compression-bonded to a connector terminal connected to a flexible board.

Therefore, the upper surface of the support plate 400 has a structure that maintains flatness as much as possible, and thus has a structure that does not readily affect flatness and inclination of the display 300J even when the display 300J is bonded to an upper portion of the support plate 400 by an adhesive or the like.

In the display device 4 according to the present embodiment, the first electrode layer (first sensor coil group 100) and a pad group 140 or a part of first sensor coil wiring are formed on the lower surface side of the support plate 400 with respect to the pen.

That is, a large current flows through the first electrode layer (first sensor coil group 100) because the first electrode layer (first sensor coil group 100) generates the alternating magnetic field. Thus, the line width of a wiring pattern forming the first electrodes is large in order to decrease impedance. When the first electrode layer (first sensor coil group 100) is formed in a layer higher than the display 300L, the visibility of the display 300L may be impaired.

In the display device 4 according to the present embodiment, the first electrode layer (first sensor coil group 100) is formed on the lower surface side of the support plate 400 with respect to the pen. It is therefore possible to thin the stack structure and improve designability while maintaining the performance of the position detecting device without impairing the visibility of the display 300L.

In addition, because the second electrode layer (second sensor coil group 200) is integrated with the touch panel TS, it is possible to thin the stack structure and improve designability while maintaining the performance of the position detecting device. In addition, because the first electrode layer (first sensor coil group 100) is formed on the support plate 400 indispensable to the display device 4 of the folding type, the above-described effects can be produced also in the display device 4 of the folding type.

In addition, the first electrode layer (first sensor coil group 100) has a structure such that the first electrode layer (first sensor coil group 100) is formed on the lower surface of the mounted support plate 400 with respect to the pen, a connector terminal on an FPC side is compression-bonded to the first electrode layer (first sensor coil group 100), and a controller is connected to the first electrode layer (first sensor coil group 100) via an FPC. In other words, the upper surface of the support plate 400 with respect to the pen remains flat, and therefore has a structure that does not affect flatness and inclination of the display 300L even when the display 300L is bonded to an upper portion of the support plate 400 by an adhesive or the like.

### First Modification

In the foregoing embodiments, in order to facilitate understanding of the described contents, functions of the first electrodes and the second electrodes have been uniquely defined and described, supposing that the first electrodes are electrodes for sending out a magnetic field and that the second electrodes are electrodes for detecting a pen signal. However, the first electrodes may operate as the first electrodes in a sending-out period for sending out the magnetic field on a time-division basis, and thereafter operate as second electrodes for detecting the pen signal on another axis (for example, the Y-axis) different from the arrangement axis (for example, the X-axis) of the second electrodes for detecting the pen signal in a detection period.

In addition, the first electrodes in the foregoing embodiments may be read as first electrodes annexed in the first direction, and the second electrodes may be read as second electrodes annexed in the second direction.

### Second Modification

Referring to FIGS. 6A to 6F, FIG. 8A, and FIG. 8B, a description has been made of drawing out a flexible board having a connector terminal connected with a pad group or a part of second sensor coil wiring or second sensor coil wiring from the lower surface sides of the support plates 400, 400-1, and 400-2. However, a flexible board having a connector terminal connected with a pad group or a part of second sensor coil wiring or second sensor coil wiring may be drawn out from the upper surface sides of the support plates 400, 400-1, and 400-2.

In that case, it is preferable to provide a notch in an end portion in the direction of drawing out the flexible board in the support plates 400, 400-1, and 400-2, change the direction of drawing out the flexible board to the lower surface sides of the support plates 400, 400-1, and 400-2 via the notch, and compression-bond the flexible board to the lower surfaces of the support plates 400, 400-1, and 400-2.

The form as described above can provide a structure that maintains flatness of the upper surfaces of the support plates 400, 400-1, and 400-2 as much as possible, and does not readily affect flatness and inclination of the displays 300G, 300J, 300L, 300M, and 300N even when the displays 300G, 300J, 300L, 300M, and 300N are bonded to an upper portion of the support plate 400 by an adhesive or the like.

In addition, by changing the direction of drawing out the flexible board via the notch, and compression-bonding the flexible board to surfaces of the support plates 400, 400-1, and 400-2, it is possible to prevent interference between a bent portion of the flexible board and the support plates 400, 400-1, and 400-2 and prevent damage to the flexible board due to a vibration or an impact.

### Third Modification

In the foregoing embodiments, the configuration of the position detecting device or the display device has been described. However, the position detecting device or the display device may be a sensor for use in conjunction with a position detecting device that includes a display layer controlling display pixels and the blinking of the display pixels and detects the position of a pen by using electromagnetic induction action. The sensor includes a first electrode layer provided with a first electrode that generates an alternating magnetic field and a second electrode layer provided with a plurality of second electrodes that detect a pen alternating magnetic field generated by the pen that has stored energy through the alternating magnetic field. The second electrode layer is on an opposite side of the display layer from a side provided with the first electrode layer.

When the sensor has the form as described above, it is possible to thin the stack structure and improve designability while maintaining the performance of the position detecting device.

### Supplementary Notes

### Supplementary Note 1

A position detecting device for detecting a position of a pen by using electromagnetic induction action, the position detecting device including:
a first electrode layer provided with a first electrode that generates an alternating magnetic field;
a display layer that controls display pixels and blinking of the display pixels; and
a second electrode layer provided with a plurality of second electrodes that detect a pen alternating magnetic field generated by the pen that has stored energy through the alternating magnetic field, the second electrode layer being on an opposite side of the display layer from a side provided with the first electrode layer,
the first electrode layer and the second electrode layer being formed in a comb shape, and
the first electrode layer and the second electrode layer forming layers independent of each other.

### Supplementary Note 2

A position detecting device for detecting a position of a pen by using electromagnetic induction action, the position detecting device including:
a first electrode layer provided with a first electrode that generates an alternating magnetic field; and
a second electrode layer provided with a plurality of second electrodes that detect a pen alternating magnetic field generated by the pen that has stored energy by the alternating magnetic field,
the first electrode layer and the second electrode layer being formed in a comb shape, and
the second electrode layer being formed, as a layer independent of the first electrode layer, on one surface side of a substrate.

### Supplementary Note 3

A display device for use in a position detecting device for detecting a position of a pen by using electromagnetic induction action, the display device including:
a display front panel;
a TFT back panel provided to a lower surface of the display front panel, the TFT back panel being coupled with TFTs that drive display pixel electrodes of a display; and
a touch panel provided on an upper portion of the display front panel,
at least either a first electrode layer or a second electrode layer being provided in the TFT back panel or the touch panel, the first electrode layer being provided with a first electrode that generates an alternating magnetic field, and a second electrode layer being provided with a plurality of second electrodes that detect a pen alternating magnetic field generated through the pen that has stored energy by the alternating magnetic field,
the first electrode layer and the second electrode layer being formed in a comb shape, and
the first electrode layer and the second electrode layer forming layers independent of each other.

### Actions and Effects of Supplementary Notes

The first electrode layer and the second electrode layer described in the supplementary notes are formed in a comb shape.

The comb-shaped electrode layers have a gap between adjacent coil sensors without the adjacent coil sensors overlapping each other and have one-turn winding.

Therefore, because the first electrode layer and the second electrode layer are formed in a comb shape, the first electrode layer and the second electrode layer can be formed on one surface of a substrate by printing. Hence, the first electrode layer and the second electrode layer can be formed as layers independent of each other.

Incidentally, the position detecting devices 1 to 3 and the display device 4 according to the present disclosure can be implemented by recording the processing of the first circuit 10 and the like on a recording medium readable by a computer system and making the first circuit 10 and the like read and execute a program recorded on the recording medium. The computer system referred to here includes an OS (operating system) and hardware such as a peripheral device.

In addition, the “computer system” is assumed to include a web page providing environment (or a display environment) in a case where a WWW (world wide web) system is used. In addition, the above-described program may be transmitted from the computer system storing the program in a storage device or the like to another computer system via a transmission medium or by a transmission wave in the transmission medium. Here, the “transmission medium” that transmits the program refers to a medium that has a function of transmitting information, such as a network (communication network) such as the Internet or a communication circuit (communication line) such as a telephone circuit.

In addition, the above-described program may be one for implementing a part of the above-described functions. Further, the above-described program may be one that can implement the above-described functions in combination with a program already recorded in the computer system, that is, the above-described program may be what is called a differential file (differential program).

Embodiments of the present disclosure have been described above in detail with reference to the drawings. However, concrete configurations are not limited to the present embodiments, but include design and the like in a scope not deviating from the spirit of the disclosure.

1. A position detecting device for detecting a position of a pen by using electromagnetic induction action, the position detecting device comprising:
a first electrode layer with a first electrode configured to generate an alternating magnetic field;
a display layer configured to control display pixels and blinking of the display pixels; and
a second electrode layer with a plurality of second electrodes configured to detect a pen alternating magnetic field generated by the pen that has stored energy through the alternating magnetic field, the second electrode layer being on an opposite side of the display layer from a side provided with the first electrode layer.

2. The position detecting device according to claim 1, wherein
the first electrode layer includes a plurality of the first electrodes in a first direction, and the second electrode layer includes the plurality of second electrodes in a second direction intersecting the first direction.

3. The position detecting device according to claim 2, further comprising:
an integrated circuit configured to derive coordinates of the pen at cross points at which the first electrodes and the second electrodes intersect one another.

4. The position detecting device according to claim 1, wherein
the second electrode layer is formed on a surface on a side of a substrate.

5. The position detecting device according to claim 4, wherein
the second electrode layer includes the plurality of second electrodes by using transparent electrodes on a side closer to the pen than the display layer.

6. The position detecting device according to claim 4, wherein
the second electrode layer is formed of coils.

7. The position detecting device according to claim 6, wherein
the coils are formed by mesh electrodes having a repetition of a predetermined local pattern.

8. The position detecting device according to claim 7, wherein
the mesh electrodes are each formed by linearly arranging two mesh portions in parallel with each other, the two mesh portions having a predetermined gap between the two mesh portions.

9. The position detecting device according to claim 8, comprising:
a first connector on an outside of an active area, the first connector being configured to connect a mesh portion on a lower side in an extending direction of the first electrode among the two mesh portions of each of the mesh electrodes and a mesh portion on an upper side in the extending direction of the first electrode among the two mesh portions of each of the mesh electrodes that are adjacent to each other with a predetermined interval between the mesh electrodes.

10. The position detecting device according to claim 9, comprising:
a coupling portion extending in a same direction as the second electrodes and not having a mesh structure on the outside of the active area, the coupling portion being configured to be coupled to the first connector connected to a mesh portion on the upper side in the extending direction of the first electrode or a mesh portion on the lower side in the extending direction of the first electrode among the two mesh portions of a mesh electrode at an edge of the active area.

11. The position detecting device according to claim 7, wherein,
in the second electrode layer, a dummy pattern, obtained by repeating a pattern having a similar visibility to that of a mesh pattern of the mesh portions, is provided in a part other than a part in which the coil shape is formed on the a side of the substrate.

12. The position detecting device according to claim 1, wherein
the first electrode layer is formed on a surface on a side of a substrate.

13. The position detecting device according to claim 12, wherein
the first electrode layer includes a plurality of the first electrodes by using transparent electrodes on a side closer to the pen than the display layer.

14. The position detecting device according to claim 13, wherein
the first electrode layer is formed in a comb shape.

15. The position detecting device according to claim 14, comprising:
a second connector configured to connect one end of the first electrode of the first electrode layer.

16. The position detecting device according to claim 15, further comprising:
a support plate, wherein
the first electrode layer is provided on a surface on a side of the support plate as the substrate.

17. A position detecting device for detecting a position of a pen by using electromagnetic induction action, the position detecting device comprising:
a first electrode layer includes a first electrode configured to generate an alternating magnetic field; and
a second electrode layer includes a plurality of second electrodes configured to detect a pen alternating magnetic field generated by the pen that has stored energy through the alternating magnetic field,
the second electrode layer being formed on a surface on a side of a substrate.

18. The position detecting device according to claim 17, wherein
the second electrode layer includes the plurality of second electrodes by using transparent electrodes on a side closer to the pen than a display layer.

19. The position detecting device according to claim 17, wherein
the second electrode layer is formed of coils.

20. The position detecting device according to claim 19, wherein
the coil shape is formed by mesh electrodes having a repetition of a predetermined local pattern.

21. The position detecting device according to claim 20, wherein
the mesh electrodes are each formed by linearly arranging two mesh portions in parallel with each other, the two mesh portions having a predetermined gap between the two mesh portions.

22. The position detecting device according to claim 21, comprising:
a connecting portion on an outside of an active area, the connecting portion being configured to connect a mesh portion on a lower side in an extending direction of the first electrode among the two mesh portions of each of the mesh electrodes and a mesh portion on an upper side in the extending direction of the first electrode among the two mesh portions of each of the mesh electrodes that are adjacent to each other with a predetermined interval between the mesh electrodes.

23. The position detecting device according to claim 22, comprising:
a coupling portion extending in a same direction as the second electrodes and on the outside of the active area, the coupling portion being configured to be coupled to the connecting portion connected to a mesh portion on the upper side in the extending direction of the first electrode or a mesh portion on the lower side in the extending direction of the first electrode among the two mesh portions of a mesh electrode at an edge of the active area.

24. The position detecting device according to claim 23, wherein,
in the second electrode layer, a dummy pattern obtained by repeating a pattern having a similar visibility to that of a mesh pattern of the mesh portions is provided in a part other than a part in which the coil shape is formed on the a side of the substrate.

25. A display device for use in a position detecting device for detecting a position of a pen by using electromagnetic induction action, the display device comprising:
a display front panel;
a thin film transistor back panel provided to a lower surface of the display front panel, the thin film transistor back panel being coupled with thin film transistors configured to drive display pixel electrodes of a display; and
a touch panel provided on an upper portion of the display front panel,
at least either a first electrode layer or a second electrode layer being provided in the thin film transistor back panel or the touch panel, the first electrode layer including a first electrode configured to generate an alternating magnetic field, and the second electrode layer including a plurality of second electrodes configured to detect a pen alternating magnetic field generated by the pen that has stored energy through the alternating magnetic field.

26. The display device according to claim 25, comprising:
a support plate provided on a lower side of the display front panel with respect to the pen, either the first electrode layer or the second electrode layer being formed on the support plate.

27. The display device according to claim 26, wherein
the first electrode layer is formed on a lower surface side of the support plate with respect to the pen, and the second electrode layer is provided in a state of being integrated with the touch panel.

28. The display device according to claim 26, wherein
the second electrode layer is formed on a lower surface side of the support plate with respect to the pen, and the first electrode layer is integrated with the touch panel.

29. The display device according to claim 26, wherein
the first electrode layer is integrated with the touch panel, the second electrode layer is formed on an upper surface side of the support plate with respect to the pen, and a pad group or a part of second sensor coil wiring is formed on a lower surface side of the support plate.

30. The display device according to claim 29, wherein
the pad group is connected, on the lower surface side of the support plate, to the second electrode layer formed on the upper surface side of the support plate via a via, and is compression-bonded to a connector terminal connected to a flexible board.

31. The display device according to claim 26, wherein
the first electrode layer is formed on a lower surface side of the support plate with respect to the pen, and the second electrode layer is integrated with the thin film transistor back panel.

32. The display device according to claim 26, wherein
the support plate is separated, the first electrode layer is formed on an upper surface side of the separated support plate with respect to the pen, a pad group or a part of first sensor coil wiring is formed on a lower surface side of the separated support plate, and the second electrode layer is provided in a state of being integrated with the touch panel.

33. The display device according to claim 32, wherein
the pad group is connected, on the lower surface side of the support plate, to the first electrode layer formed on the upper surface side of the separated support plate via a via, and is compression-bonded to a connector terminal connected to a flexible board.

34. The display device according to claim 26, wherein
the support plate is separated, the first electrode layer is formed on a lower surface side of the separated support plate with respect to the pen, and the second electrode layer is integrated with the touch panel.

35. A sensor for use in conjunction with a position detecting device that includes a display layer configured to control display pixels and blinking of the display pixels and is configured to detect a position of a pen by using electromagnetic induction action, the sensor comprising:
a first electrode layer provided with a first electrode configured to generate an alternating magnetic field; and
a second electrode layer provided with a plurality of second electrodes configured to detect a pen alternating magnetic field generated by the pen that has stored energy through the alternating magnetic field, the second electrode layer being on an opposite side of the display layer from a side provided with the first electrode layer.
